(19) United States
(12) Patent Application Publication
(10) Pub. No.: US 2024/0380480 A1
(43) Pub. Date: Nov. 14, 2024

(54) COMMUNICATION PARAMETER SELECTION WITH DYNAMIC BANDWIDTH ALLOCATION

(71) Applicant: Hughes Network Systems, LLC, Germantown, MD (US)

(72) Inventors: Tahereh Fazel, Potomac, MD (US); James Jehong Jong, North Potomac, MD (US); Nassir BenAmmar, North Bethesda, MD (US)

(21) Appl. No.: 18/660,881

(22) Filed: May 10, 2024

Related U.S. Application Data
(60) Provisional application No. 63/465,739, filed on May 11, 2023.

(51) Int. Cl. H04B 7/185; H04W 72/04

(52) U.S. Cl. CPC H04B 7/18513; H04W 72/04

(57) ABSTRACT

Methods, systems, and apparatus, including computer programs encoded on computer storage media, for dynamic communication parameter selection. In some implementations, a system determines a number of resource blocks to use for one or more communications between a terminal and a gateway in a satellite communication network. The system determines a characteristic of a wireless channel used for communication, and selects a table that specifies transmission parameters to use for different combinations of numbers of resource blocks and wireless channel characteristics. The system determines transmission parameters based on an entry, retrieved from the identified table, that corresponds to the determined number of resource blocks and the determined characteristic of the wireless channel.

### CROSS-REFERENCE TO RELATED APPLICATIONS

This application claims the benefit of U.S. Provisional Application No. 63/465,739 filed on May 11, 2023, which is incorporated herein by reference.

### TECHNICAL FIELD

This specification relates generally to communication systems, including systems that can select modulation and coding parameters for terminals to utilize when communicating over satellite communication networks.

### BACKGROUND

Satellite communication systems often attempt to operate with high efficiency. In such systems, it can often be desirable to maximize throughput within an allotted or designated bandwidth given constraints of the system. For example, the satellite communication system may seek to operate at a target performance but fail to meet the target performance due to disruptions in a satellite communication link, physical distortions of the transmitted signal over the satellite communication link, and communication delays caused by long distances between the devices, to name a few examples. Moreover, the receivers and transmitters utilized in the satellite communication system may be non-ideal due to implementation and processing constraints, which can exacerbate the degradations in the communications over the satellite communication link.

### SUMMARY

In some implementations, a satellite communication system can use techniques for enhancing communications of communication devices over a satellite network. The satellite communication system can be configured to determine communication parameters for the communications of the communication devices to meet a target level of performance. In some cases, the communication or transmission parameters can be selected so that these communications minimize the amount of bandwidth utilized while maximizing the throughput. However, these criteria may require a signal-to-noise ratio (SNR) that is higher than is actually achievable given receiver characteristics, channel conditions, and other factors. In some cases, if the satellite communication system sets a target performance level or target efficiency that is too high, the communication devices may need to retransmit data in the event of likely data loss, which can cause even further delays.

By analyzing the various constraints, the satellite communication system can identify the communication parameters for individual communication devices that satisfy the constraints. The system can determine different sets of communication parameters for different terminals, based on the different hardware characteristics, channel conditions, and other factors for the terminals. For example, the system can select, for a particular terminal, the communication parameters that provide high efficiency of spectrum use while keeping error rates below a threshold level. The system can take into account the receiver characteristics of the terminal, the channel conditions experienced by the terminal (e.g., signal-to-noise ratio (SNR) or signal-to-interference-and-noise ratio (SINR)) in order to set parameters such as modulation, forward error correction coding, and so on that attempt to maximize efficiency (e.g., high throughput with low spectrum usage) while still keeping bit error rates below a predetermined maximum threshold. This process can improve overall efficiency in the satellite network by, for example, setting communication parameters to achieve high efficiency, but not so high that reliability is reduced or that error rates increase to lower efficiency by causing increased need for re-transmission.

When the communication parameters for communication devices are determined, the satellite communication system can transmit the identified communication parameters to the respective communication devices to use for subsequent transmissions over the satellite network. In some implementations, the satellite communication system can determine communication parameters for multiple communication devices located at disparate geographic regions and deploy the determined communication parameters to each respective communication device over the satellite network for their subsequent transmissions.

In some implementations, the satellite communication system can include a gateway and multiple terminals that communicate over a satellite. In some cases, the gateway can determine the communication parameters for each terminal based on a return signal quality of prior transmissions from the terminal or a return link prediction based on a location of the terminal. In some cases, the gateway can receive a request from a particular terminal over the satellite. Based on the request, the gateway can select communication parameters for subsequent transmissions for the requesting terminal in order to maximize a transmission data rate or spectrum efficiency level while maintaining the target performance level, e.g., a predetermined target error rate. The gateway can analyze various characteristics associated with the request to determine the selected communication parameters for subsequent transmissions by the requesting terminal. These characteristics can include, for example, measured conditions of the satellite communication channel, performance data of the receiver at the gateway, allocated bandwidth for the terminal's transmissions, the desired data transmission size, system configuration information, and a target performance for the terminal's transmissions. The gateway can identify the suitable communication parameters, which include, for example, a modulation and coding scheme (MCS), a number of Resource Blocks (RBs), and a Transport Block Size (TBS), for the requesting terminal using the characteristics, as will be explained below. In response to identifying the suitable communication parameters, the gateway can transmit the suitable communication parameters to the requesting terminal.

The gateway can select the communication parameters to ensure the satellite communication system supports a target performance. The target performance or target block error rate (BLER), for example, is selected to ensure a designated performance of the receiver at the gateway and to ensure a maximum amount of data is transmitted by the terminal within the allotted bandwidth. In some cases, the satellite link may distort or drop transmitted data due to communication issues. Packet losses may be attributed to inefficient components at the terminal's transmitter, and inefficient components at the gateway's receiver, to name a few examples, each of which ultimately can degrade the overall performance. Additionally, as the terminal increases the amount of information being transmitted, these inefficiencies can compound, which can more severely degrade the overall system performance even further. As such, the gateway can select suitable communication parameters, e.g., MCS, number of RBs, and TBS, for the terminal to ensure the target BLER is met for the gateway receiver's performance while maximizing the amount of data transmitted from the terminal. This will be further described below.

In some implementations, the gateway can utilize one or more algorithms that analyze various characteristics to identify the communication parameters for the terminal in real time or substantially real time. When the gateway receives a request from the terminal, the gateway can identify various characteristics associated with the request and input these characteristics, e.g., the condition of the satellite communication channel, performance data of the receiver at the gateway, and others, into the one or more algorithms. The one or more algorithms process these characteristics and can output the optimized communication parameters. In response, the gateway can transmit the optimized communication parameters to the terminal for subsequent transmissions.

In some implementations, the gateway can utilize a lookup table (LUT) to select the communication parameters for the terminal to use. The gateway can store multiple sets of LUTs that each correspond to different situations. For example, different LUTs can be used for different transmitter type or transmitter models, for different receiver types or receiver models, for different target error rates, for different levels of communication overhead or for different communication protocol options or (e.g., whether Uplink Control Information (UCI), Sounding Reference Signal (SRS), and Channel Quality Information (CQI), Hybrid Automatic Repeat Request (HARQ), or other features are available or are being used), and so on. Different LUTs can be generated and stored for different combinations of these features, e.g., with a LUT for transmitter Model A, receiver Model B, with target error rate or error probability of 10⁻³, etc., and with different LUTs for different combinations of transmitter model, receiver model, target error rate, and so on. Each LUT can be an array or matrix of data that maps input values to output values. In many cases, the factors such as transmitter model, receiver model, target error rate, and communication protocol options are used to select an appropriate LUT. Values such as the number of RBs to be used and the signal-to-noise ratio (SNR) serve as index values that the gateway can use to retrieve a MCS code that indicates the modulation and forward error correction for the terminal to use.

The gateway or another external device can generate one or more LUTs that store a set of communication parameters, e.g., identifiers or codes representing different modulation and coding schemes (MCSs), with the various MCSs being indexed according to signal-to-noise ratios (SNRs) and a number of available RBs. The one or more LUTs can be generated offline and/or prior to communications between the gateway and the various terminals. Then, when the gateway receives a request from the terminal, the gateway can select an MCS entry from a LUT according to the given SNR and the number of available RBs from the requesting terminal. The LUT can be generated so that the MCS entries in a LUT each indicate a modulation and coding that is estimated to achieve a target error rate given the corresponding situation (e.g., for the number of RBs and the SNR value used as index values for the MCS entry, as well as for the transmitter type, receiver type, etc. corresponding to the LUT as a whole). For example, one LUT may assign MCSs so that each is estimated to product the same target error rate, e.g., a 10⁻³ error rate or a one in a thousand chance that a block will need to be retransmitted. This technique thus provides an effective way to balance competing factors that affect spectral efficiency, such as a desire to maximize throughput for each transmission and also the need to avoid the loss in efficiency due to retransmissions. Retransmitting a transport block is has a very negative effect on efficiency, and with the techniques discussed in this document, transmission parameters can be set to limit the likelihood that retransmission is needed to a defined level. Further, the system operator can adjust the target error rate that the system uses to tune transmission parameters, such as by using LUTs generated for a different target error rate, to adjust the tradeoff between throughput and rate of retransmissions.

In some implementations, the one or more LUTs can be stored in a terminal, allowing the terminal to select an MCS entry to use in making a subsequent transmission without having to communicate with the gateway prior to sending a transmission.

In one general aspect, a method includes: determining a number of resource blocks to use for one or more communications between a terminal and a gateway in a satellite communication network, where the number of resource blocks indicates an amount of frequency bandwidth to use for the one or more communications; determining a characteristic of a wireless channel used for communication between the terminal and the gateway in the satellite communication network; selecting a table from a plurality of tables, where each of the tables specifies transmission parameters to use for different combinations of (i) values indicating different numbers of resource blocks and (ii) values indicating different wireless channel characteristics; determining transmission parameters for making the one or more communications between the terminal and the gateway based on an entry, retrieved from the identified table, that corresponds to (i) the determined number of resource blocks and (ii) the determined characteristic of the wireless channel; and causing one or more transmissions to be sent between the terminal and the gateway using the determined transmission parameters.

Other embodiments of these and other aspects of the disclosure include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The foregoing and other embodiments can each optionally include one or more of the following features, alone or in combination. For example, one embodiment includes all the following features in combination.

In some implementations, the method is performed by the terminal using tables stored by the terminal.

In some implementations, the method is performed by the gateway using tables stored by the gateway.

In some implementations, determining the transmission parameters includes determining the transmission parameters for a transmission in a forward direction involving downlink from the gateway to the terminal.

In some implementations, determining the transmission parameters includes determining the transmission parameters for a transmission in a reverse direction involving uplink from the terminal to the gateway.

In some implementations, determining the transmission parameters includes determining, by the gateway, transmission parameters for a subsequent transmission from the terminal to the gateway. Causing the one or more transmissions to be sent between the terminal and the gateway using the determined transmission parameters includes transmitting the determined transmission parameters to the terminal over the satellite communication network, such that the terminal transmits the subsequent transmission to the gateway using the determined transmission parameters.

In some implementations, determining the transmission parameters includes at least one of (i) determining a modulation or (ii) determining a forward error correction coding.

In some implementations, the selected table includes entries for each of multiple combinations of a number of resource blocks and a wireless channel characteristic, and the entries each specify transmission parameters that are calculated to provide a same predetermined target error rate for reception of transmissions over the satellite communication network made using the combination corresponding to the entry.

In some implementations, the entries in the selected table each specify a modulation and coding scheme (MCS) from a predetermined set of MCSs. Each of the entries in the selected table is set based on a same predetermined target error rate such that each entry specifies the MCS, from among the predetermined set of MCSs, that is calculated to provide an error rate that is closest to the predetermined target error rate or is closest to the predetermined target error rate without exceeding the predetermined target error rate.

In some implementations, the entries in the selected table each specify a modulation and coding scheme (MCS) from a predetermined set of MCSs. Each of the entries in the selected table is set based on a same predetermined target error rate such that each entry specifies the MCS, from among the predetermined set of MCSs, that is calculated to maximize throughput over the satellite communication network for communication between the terminal and the gateway without exceeding the target error rate.

In some implementations, the entries in the selected table each specify a modulation and coding scheme (MCS) from a predetermined set of MCSs. The entries in the selected table are set to MCSs, selected from among the predetermined set of MCSs, that are calculated to achieve a same tradeoff between a level of throughput over the satellite communication network and a likelihood that retransmission of a message is needed, where the tradeoff is set using a predetermined target error rate.

In some implementations, the target error rate is a block-level error rate.

In some implementations, the target error rate is a block-level error rate indicating a frequency or probability with which a transport block or a message transmitted will be received with an uncorrectable error that requires retransmission of the transport block or message.

In some implementations, entries in the tables specify transmission parameters that include at least one of a modulation or forward error correction coding, and the entries are determined based on analysis of measured performance of actual receivers and/or transmitters transmitting with the transmission parameters specified in the entries.

In some implementations, determining the characteristic of the wireless channel includes determining a signal-to-noise ratio (SNR) for the terminal or a signal-to-interference-and-noise ratio (SINR) for the terminal.

In some implementations, determining the characteristic of the wireless channel includes determining a characteristic of forward channel transmission from the gateway to the terminal, where the characteristic is determined by the gateway based on a measurement by the terminal that is reported to the gateway.

In some implementations, determining the characteristic of the wireless channel includes determining a characteristic of reverse channel transmission from the terminal to the gateway, where the characteristic is measured by the gateway based on signal characteristics of one or more transmissions from the terminal.

In some implementations, determining the characteristic of the wireless channel includes estimating a signal-to-noise ratio (SNR) for the terminal or a signal-to-interference-and-noise ratio (SINR) for the terminal based on a geographical location of the terminal.

In some implementations, the plurality of tables includes different lookup tables corresponding to different communication protocol features. Selecting a table from the plurality of tables includes: identifying a set of communication protocol features used for communication between the terminal and the gateway; and selecting, from among the plurality of tables, a table corresponding to the identified set of communication protocol features.

In some implementations, the different communication protocol features comprise different levels of communication channel overhead or different settings of whether one or more of uplink control information (UCI), sounding reference signal (SRS), and channel quality information (CQI), or hybrid automatic repeat request (HARQ) are used for communication between the terminal and the gateway.

In some implementations, the plurality of tables includes different lookup tables corresponding to different target error rates. Selecting a table from the plurality of tables includes: identifying a target error rate for communication between the terminal and the gateway; and selecting, from among the plurality of tables, a table corresponding to the identified target error rate.

In some implementations, the plurality of tables includes different lookup tables corresponding to different receiver types. Selecting a table from the plurality of tables includes: identifying a receiver type for communication between the terminal and the gateway; and selecting, from among the plurality of tables, a table corresponding to the identified receiver type

In some implementations, the different lookup tables each have entries that are set based on measured performance of receivers of the corresponding receiver type.

In some implementations, the plurality of tables includes different lookup tables corresponding to different transmitter types. Selecting a table from the plurality of tables includes: identifying a transmitter type for communication between the terminal and the gateway; and selecting, from among the plurality of tables, a table corresponding to the identified transmitter type.

In some implementations, the different lookup tables each have entries are set based on measured performance of reception from transmissions of transmitters of the corresponding transmitter type.

In some implementations, the method includes: receiving, by the gateway and from the terminal, the request for transmission parameters for the terminal to use for subsequent transmissions from the terminal to the gateway; and sending the selected transmission parameters from the gateway to the terminal.

In some implementations, determining the number of resource blocks includes determining a number of resource blocks based on at least one of (i) an available number of resource blocks or (ii) an unavailable number of resource blocks that were allocated to other terminals that communicate with the gateway over the satellite network.

In some implementations, the method includes: demodulating data indicative of the received request according to a modulation scheme utilized by the terminal; extracting the number of resource blocks from the demodulated data, where extracting the number of resource blocks from the demodulated data includes: identifying at least one subframe in the demodulated data;
detecting a number of symbols in the at least one subframe of the request; and determining the number of resource blocks utilized using the detected number of symbols in the at least one subframe.

In some implementations, the method includes selecting, from the plurality of tables, the table for a specific type of receiver of the terminal or the gateway, where each table of the plurality of tables is based on actual measured performance data from receivers, and at least some of the tables correspond to different types of receivers and each have include transmission parameters determined based on the actual measured performance from receivers of the corresponding type of receiver.

In some implementations, the method includes determining a transport block size representing a number of bits to be sent in a communication between the terminal and the gateway. The determined block size is used to select the table from among the plurality of tables or to determine the transmission parameters using the selected table.

In some implementations, the method includes receiving, by the gateway, a request from the terminal, where the request indicates a number of bits for terminal to transmit to the gateway over the satellite network in a subsequent transmission, and based on the request, determining, by the gateway, the transmission parameters for the terminal to transmit the number of bits in the subsequent transmissions, where the transmission parameters are determined, using the selected table, with values calculated to enable reception, by the gateway, of transport blocks from the terminal having the indicated number of bits at (i) a predetermined target error rate or (ii) no more than a predetermined maximum error rate.

In some implementations, the transmission parameters are calculated based on effects of transmission of the number of bits by the terminal, effects of the wireless channel on the transmitted bits, and effects of reception at the gateway.

In some implementations, determining the transmission parameters includes identifying, from the selected table, transmission parameters selected, from among a set of transmission parameters, to enable reception by the gateway of transmissions by the terminal that maximize throughput with no more than the predetermined maximum error rate.

In some implementations, determining the transmission parameters includes determining, using a selection algorithm, transmission parameters selected from among a set of transmission parameters such that transport blocks having a size of the number of bits indicated by the request maximize throughput without exceeding a predetermined maximum error rate.

In some implementations, selecting the table from the plurality of tables includes: selecting the table from the plurality of tables according to one or more communication properties for communication between the terminal and the gateway, where the communication properties comprise at least one of (i) a type of receiver used at the gateway, (ii) a type of transmitter used at the terminal, (iii) a number of control bits are included in the communications between the terminal and the gateway, or (iv) whether channel quality indicator information is included in communications between the terminal and the gateway, or (v) one or more properties of a physical uplink shared channel (PUSCH) for the communications between the terminal and the gateway. The selected table stores modulation and coding parameters calculated for a type of receiver utilized at the gateway and a type of transmitter utilized at the terminal.

In some implementations, the control bits comprise control bits for at least one of Uplink Control Information (UCI), Sounding Reference Signal (SRS), or Channel Quality Information (CQI).

In some implementations, the plurality of tables comprise different tables for different terminal models.

In some implementations, the plurality of tables includes different tables corresponding to different target error rates.

In some implementations, the plurality of tables includes different tables corresponding to different target error rates for different receiver models.

In some implementations, each of the tables includes series of transmission parameters, from among a set of available transmission parameters, respectively calculated to maximize throughput while resulting in no more than a predetermined maximum error rate under different amounts of resource blocks and different wireless channel characteristics.

In some implementations, the plurality of tables includes different tables generated based on characteristics of the receiver of the gateway, including different tables configured to provide transmission parameters calculated to achieve different target error rates.

In some implementations, the at least one subframe comprises 14 symbols and a length of 1 millisecond.

In some implementations, determining the number of resource blocks includes determining the number of resource blocks in a symbol of the 14 symbols in the at least one subframe.

In some implementations, 12 of the 14 symbols in the at least one subframe include a normal physical uplink shared channel (PUSCH).

In some implementations, 11 of the 14 symbols in the at least one subframe represent a shortened PUSCH, and a remaining 3 symbols represent sounding information (SRS).

In some implementations, the request for the transmission parameters for the terminal to use represents a number of bits the terminal desires to transmit to the gateway over the satellite network for the subsequent transmissions, and based on the request, determining the transmission parameters for the terminal to transmit the number of bits such that the gateway is configured to decode the number of bits transmitted according to a target block error rate.

In another general aspect, a method includes: obtaining, for a particular type of receiver, performance data indicating error rates across a series of signal quality levels for each of a plurality of numbers of resource blocks and a plurality of modulation and coding schemes; estimating achievable effective rates of communication using the obtained error rates, where the estimated achievable effective rates characterize performance of receivers of the particular type of receiver measured across the series of signal quality levels, a plurality of modulation and coding schemes, and a plurality of resource blocks; determining, for the particular type of receiver, a relationship between the series of signal quality levels and the estimated achievable effective rate of the receiver; extracting characteristics of the determined relationship, where the extracted characteristics include (i) a slope of the determined relationship and (ii) an offset value of the determined relationship; and generating, for the receiver, one or more tables based on the extracted characteristics, where the one or more tables each specify different modulation and coding schemes calculated to achieve a same target error rate for different numbers of resource blocks and different levels of signal quality.

In some implementations, determining the relationship includes performing a linear regression.

In some implementations, the series of signal quality levels includes a series of signal-to-noise ratio (SNR) values or a signal-to-interference-and-noise ratio (SINR) values.

In some implementations, the target error rate is a block-level error rate.

In some implementations, the target error rate is a block-level error rate indicating a frequency or probability with which a transport block or a message transmitted will be received with an uncorrectable error that requires retransmission of the transport block or message.

In some implementations, the method includes obtaining performance data indicating error rates for each of multiple different types of receiver; and generating one or more tables for each of the different types of receiver.

In some implementations, the method includes: obtaining performance data indicating error rates for each of multiple different amounts of control bits or communication protocol overhead; and generating one or more tables for each of the different amounts of control bits or communication protocol overhead.

In some implementations, the different amounts of control bits or communication protocol overhead comprise different settings of whether one or more of uplink control information (UCI), sounding reference signal (SRS), and channel quality information (CQI), or hybrid automatic repeat request (HARQ) are used for communication.

In some implementations, the method includes generating multiple tables for the particular type of receiver, including at least some tables that specify modulation and coding schemes calculated to achieve a different target error rates.

In some implementations, the method includes: obtaining performance data indicating error rates for each of multiple different types of transmitter; and generating one or more tables for each of the different types of transmitter.

In some implementations, generating a table includes: for each number of resource blocks of a series of numbers of resource blocks: for each transport block size in a series of transport block sizes: determining a first achievable effective rate using one or more of (i) the transport block size, (ii) the number of resource blocks, (iii) a number of subcarriers in a subframe, (iv) a number of symbols in the subframe, (v) a number of control bits, and (vi) a number of bits in cyclic redundancy check; and determining a temporary SNR value using (i) the determined first achievable effective rate and (ii) the extracted characteristics of the determined relationship

In some implementations, generating the table includes: in response to determining that the determined temporary SNR value is less than an SNR value of a characteristic of a satellite network: selecting a respective modulation and coding scheme according to the transport block size and the resource block; and setting, as an entry in the table, the selected modulation and coding scheme based on indexing with the resource block and the determined temporary SNR.

In some implementations, generating the table includes: in response to determining that the temporary SNR is not less than the SNR value of the characteristics of the satellite network for each resource block and each transport block size: for each transport block size in a series of transport block sizes: determining a second achievable effective rate using (i) the transport block size, (ii) the number of bits in the cyclic redundancy check, (iii) an available resource block, (iii) the number of subcarriers in the subframe, and (iv) the plurality of control bits; determining a threshold using (i) the extracted characteristics of the determined relationship and (ii) an SNR value of the characteristics of the satellite network; and if the second achievable effective rate satisfies the threshold: determining a modulation and coding scheme according to the transport block size and the available resource block; and setting, as the entry in the table, the determining modulation and coding scheme based on indexing with the available resource block and the SNR value of the characteristics of the satellite network.

The subject matter described in this specification can be implemented in various embodiments and may result in one or more of the following advantages. In some implementations, the system can improve the overall communication between terminals by accurately selecting the suitable MCS, number of RBs, and TBS, in the presence of Uplink Control Information (UCI) and Sounding Reference Signal (SRS) under any given channel condition or any received SNR measurement. As a result, the system can adapt the communication parameters to any network environment and ensure communication persists between the terminals and the gateway at a high performance. Moreover, the system can adapt the selection of communication parameters to improve the inefficiencies of the communication devices, e.g., a gateway's receiver. As will be further described below, the system can generate load performance curves for a receiver that estimates the receiver's performance across different SNR values, and more specifically, monitor the receiver's performance for different MCS values. The system can tailor its algorithm using the generated load performance curves for the receiver in order to ensure that a desired performance level is met during implementation of the communication parameter selection. In this manner, the system can improve the usage of the terminal even when inefficiencies exist with components of the gateway and/or terminal.

In some cases, the system can determine appropriate communication parameters for terminals with low latency and low computational complexity. Many parameter selection algorithms involve intensive processing. However, the system can avoid the need for this intensive processing for most parameter selections. The system can calculate the appropriate communication parameters for many different situations in advance and store the results, such as in a tabulated form such as in lookup tables. The lookup tables can be sent to or used by many different gateways, terminals, or other communication devices. Using the pre-computed tables, devices can look up appropriate communication parameters very quickly and with low processing requirement. For example, information about a particular situation (e.g., SNR, receiver type, etc.) can be used to select an appropriate table and set index values to retrieve communication parameters from the tables. The efficiency of this process allows parameters to be selected at a large scale with low latency, high power efficiency, and low processing requirements.

In some cases, the system also provides a high level of flexibility and versatility. If there are hardware changes for a gateway or a terminal, the MCS parameter entries in the tables can be recalculated offline and updated to reflect the differences in hardware and hardware performance. In this manner, the system can quickly and effectively adapt to changes in hardware by updating tables or providing new tables when appropriate.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a diagram that shows an example of a system for dynamically selecting communication parameters for a terminal.

FIG. 1B is a diagram that shows an example of a system for generating a lookup table used for selecting communication parameters.

FIG. 1C illustrates an example of a graph that displays receiver performance across different SNR values.

FIG. 1D illustrates an example of a graph that displays receiver achievable effective rate (AER) performance across various SNR values.

FIGS. 1E and 1F illustrate examples of graphs for approximating SNR and AER relationships for a particular receiver.

FIG. 1G illustrates an example of a block diagram for generating the one or more lookup tables for a few example combinations of number of RBs and values of SNR.

FIGS. 1H and 1I illustrate examples of algorithms executed to select a suitable MCS, number of RBs, and TBS for a terminal that communicates with a gateway.

FIG. 2 is a diagram showing an example of symbols transmitted in a physical uplink shared channel (PUSCH).

FIG. 3 is a diagram that shows an example of a lookup table for selecting a modulation and coding scheme.

FIG. 4 is a flow diagram that illustrates an example of a process for selecting communication parameters for a terminal in a satellite communication network.

Like reference numbers and designations in the various drawings indicate like elements.

### DETAILED DESCRIPTION

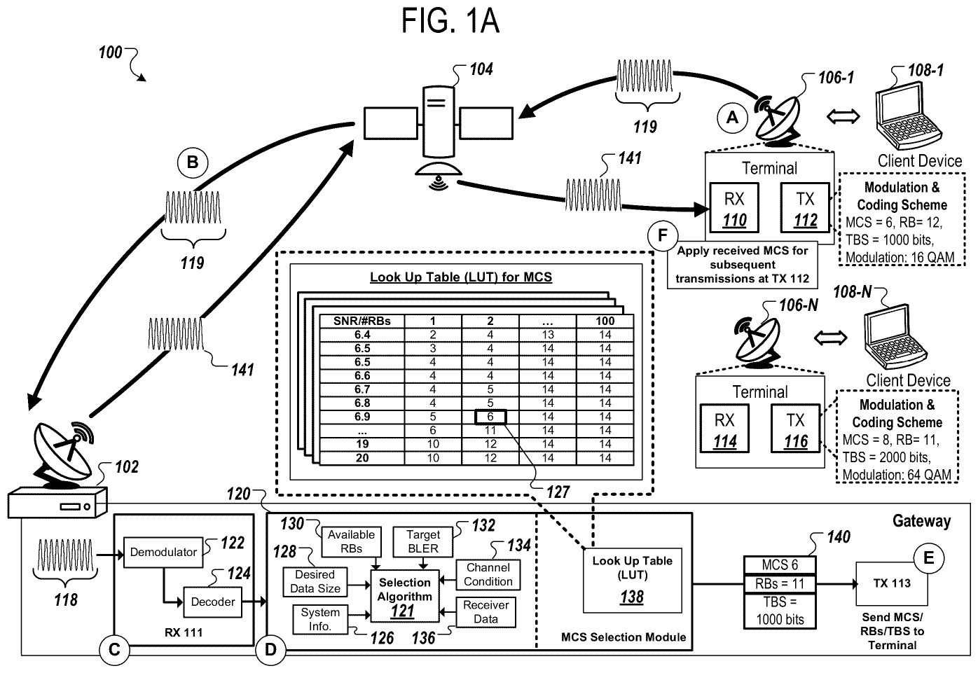

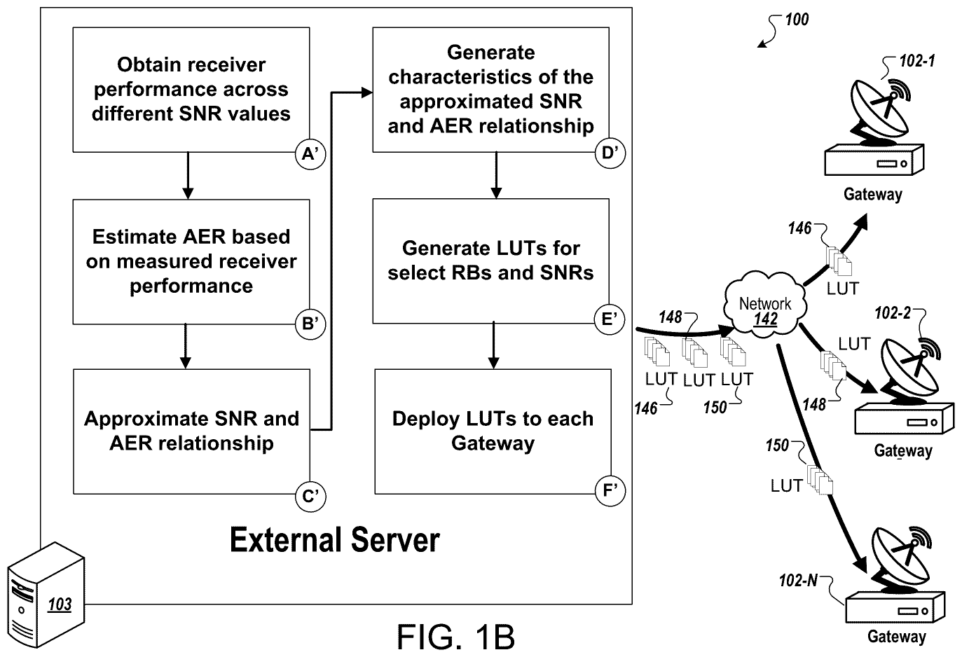

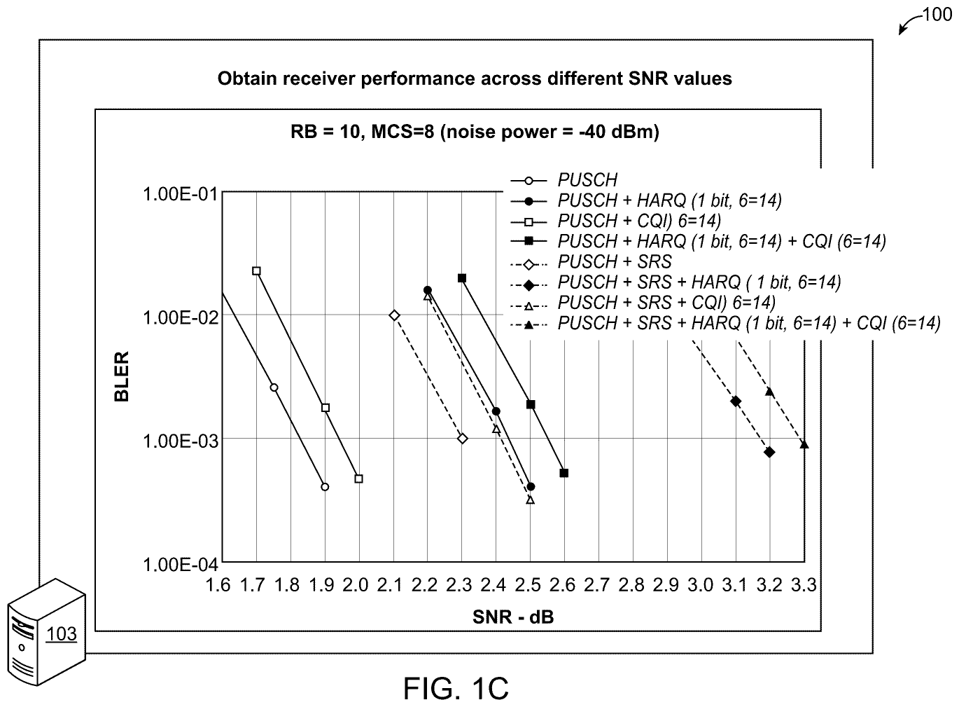

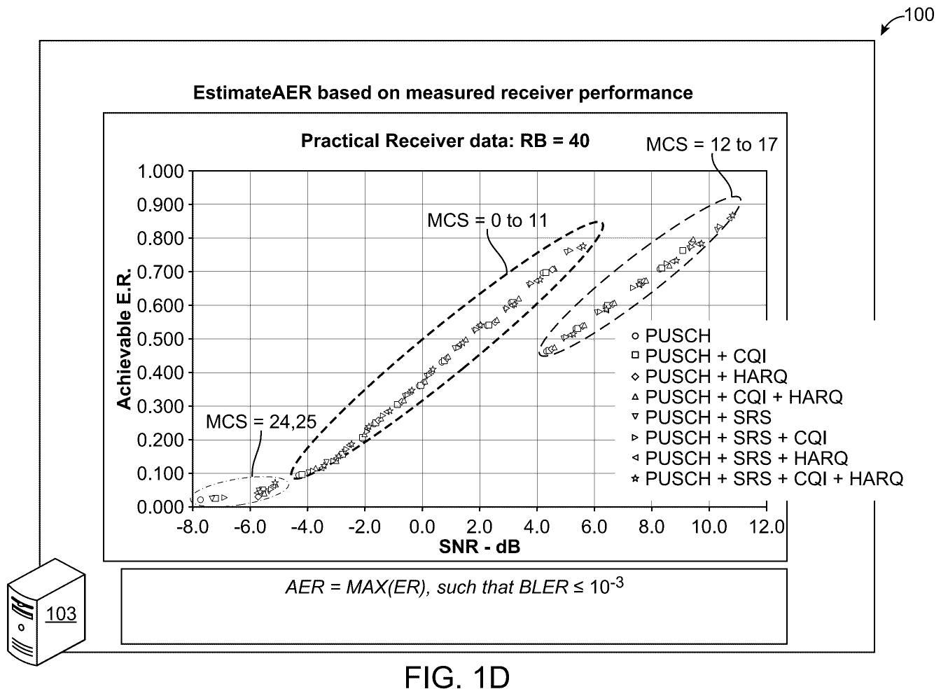

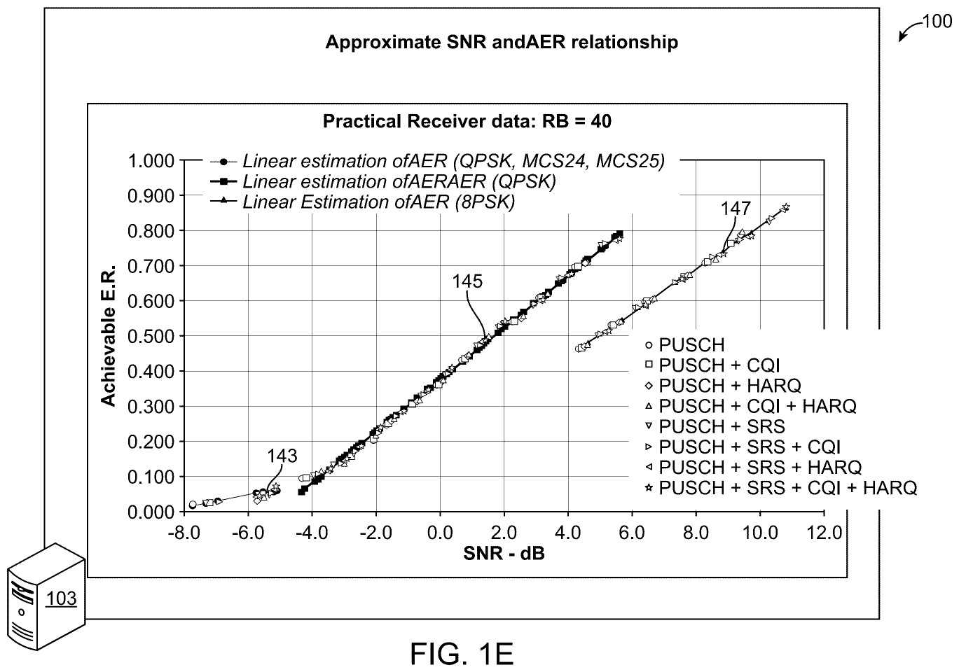

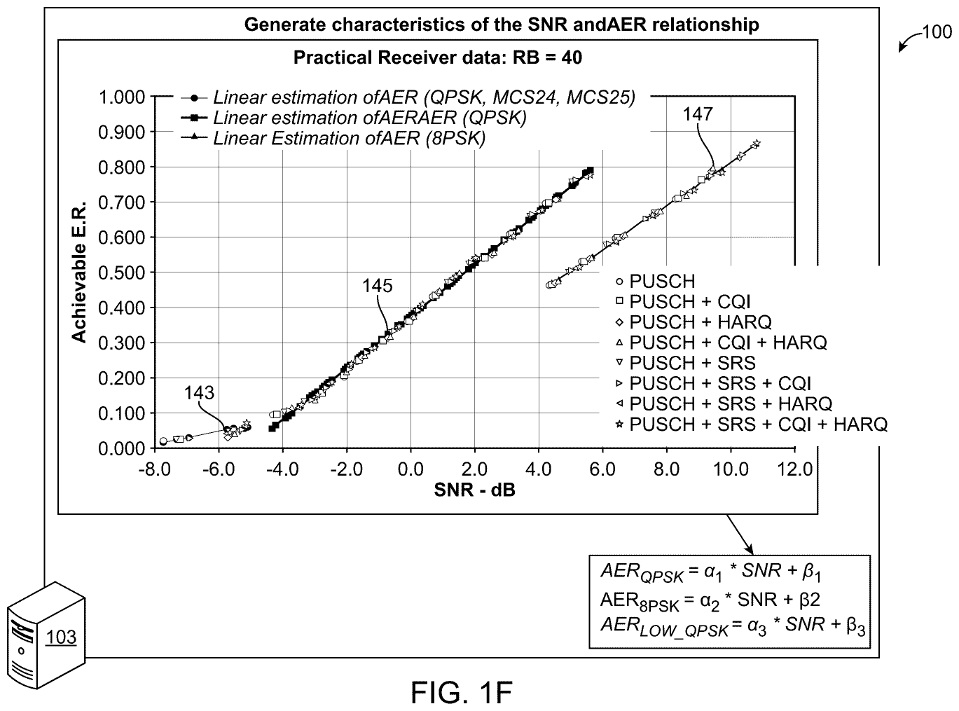

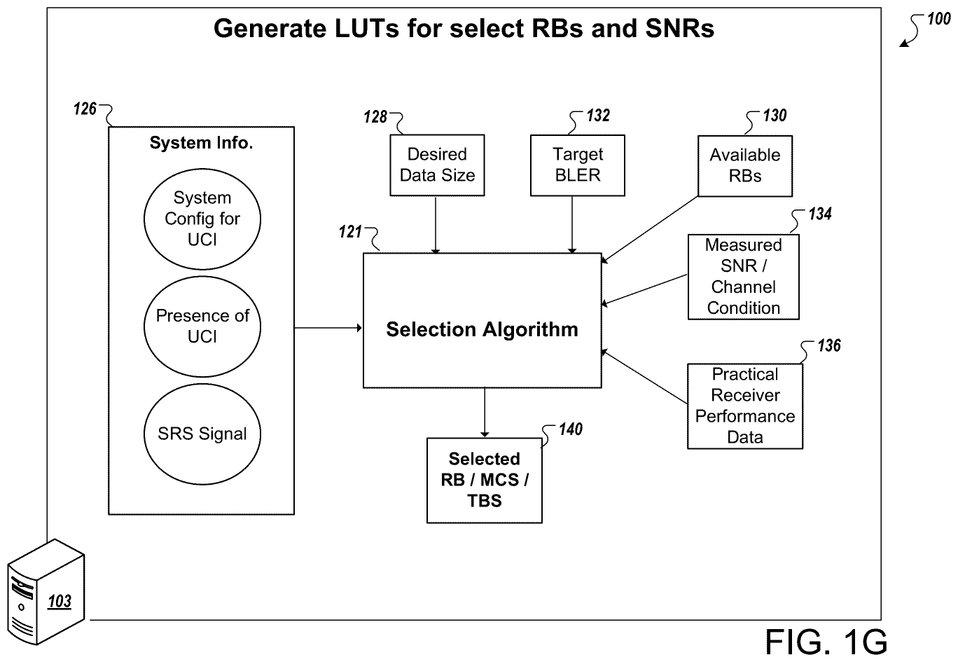

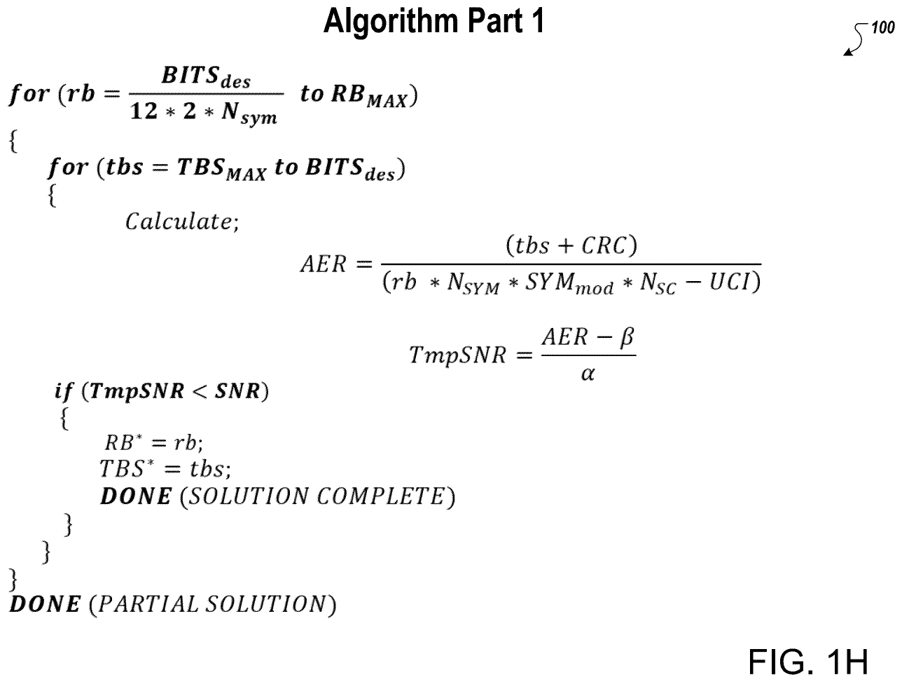

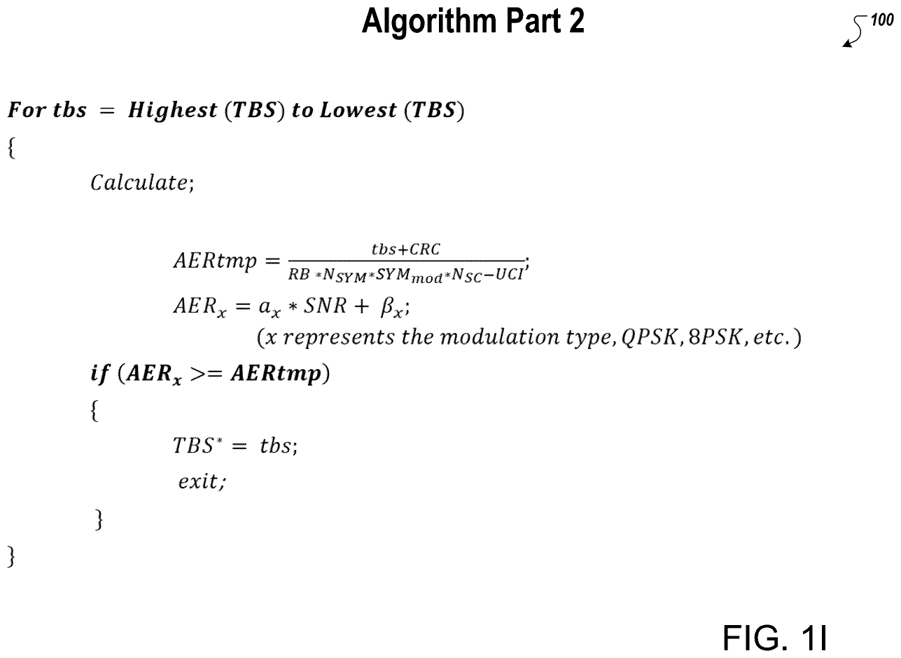

FIG. 1A is a diagram that shows an example of a system 100 for dynamically selecting communication parameters for a terminal. The example of FIG. 1A illustrates satellite communication, but the techniques described here can be used in other wireless communication systems. The system 100 includes a gateway 102 that communicates with a satellite 104, and the satellite 104 communicates with various satellite terminals 106-1 through 106-N (collectively “terminals 106”). The satellite 104 and the gateway 102 (along with other network components), can cooperate to transfer data to and from the terminals 106. The gateway 102 may communicate with one or more backend servers over a network, such as the Internet.

Each of the terminals 106 can be in communication with and provide network service to one or more client devices 108, such as hand-held devices, telephones, laptop computers, desktop computers, Internet of Things (IoT) devices, and other devices. For example, the terminals 106 can each be very small aperture terminals (VSATs). Each of the client devices 108 can make use of the network service provided by their corresponding terminals 106, which enables the client device 108 to access gateway 102 through the network over the satellite 104. For example, as illustrated in FIG. 1A, the terminal 106-1 can provide network service to the client device 108-1 and the terminal 106-N can provide network service to the client device 108-N. In some cases, each of the terminals 106 can provide network services to more than one client device 108.

In some implementations, the gateway 102 can include various components that enable transmission and reception in the system 100. In some examples, the gateway 102 can include various routers for communicating with various external servers. Similarly, the gateway 102 can include a transmitter that includes a radio frequency (RF) transmit chain and an antenna for transmitting data to the satellite network over satellite 104. The gateway 102 can include a receiver that includes an RF receive chain and an antenna for receiver data from the satellite network. The transmitter can include components related to coding, modulating, and upconverting of symbols to be prepared for transmission. Similarly, the receiver can include components related to downconverting, demodulating, and decoding of received symbols.

In some implementations, each of the terminals 106 can include various components that enable transmission and reception in the satellite network. For example, each of the terminals 106 can include a transmitter that includes an RF transmit chain that performs modulation and upconversion to prepares one or more symbols for transmission. The transmitter also includes an antenna for transmitting the symbols over the satellite network. Similarly, each of the terminals 106 can include a receiver that includes an RF receive chain that receives, downconverts, and demodulates signals. Additionally, the receiver can include an antenna for receiving symbols over the satellite network. As illustrated in the example of system 100, terminal 106-1 includes a receiver 110 and a transmitter 112. Terminal 106-N can include a receiver 114 and a transmitter 116.

The satellite 104 can include capabilities for transmitting and receiving with different components of the system 100. For example, the system 100 provides a satellite communication link with bi-directional communication over satellite 104. Through the satellite communication link, the terminals 106 can receive forward channel data, such as data that the gateway 102 can provide from the Internet or a core network for telecommunications, e.g., a core network for 4G/LTE, 5G, or 6G communications. The satellite communication link also enables the terminals 106 to send return channel data, such as data provided by the client devices 108, to the gateway 102. In this manner, the multiple terminals 106 and the gateway 102 can share the satellite communication link when performing transmitting their respective data streams.

In some implementations, the system 100 can employ the satellite 104, the gateway 102, and the one or more terminals 106 to communicate using a particular communication scheme. For example, the communication scheme can include a 3G communication scheme, a 4G communication scheme, a 5G communication scheme, or another communication scheme. Typically, in 5G communications, the terminals 106 and the gateway 102 communicate using orthogonal frequency-division multiplexing (OFDM) such that a signal has a carrier and multiple sub-carriers. For example, a carrier or a channel can have a width of 5 MHz. Within a 5 MHZ carrier or channel, there may be 25 Resource Blocks (RBs), and each RB occupies a particular bandwidth, such as 180 KHz. Thus the number of resource blocks allocated to or used by a terminal indicates the amount of frequency bandwidth allocated or used, as a number of frequency or spectrum units being dedicated for that terminal during its transmission time. Within each RB, there are 12 subcarriers that occupy a 15 KHz subcarrier spacing. Alternatively, the number of RBs can range between 1 and 275 in 5G. Moreover, in an LTE or 4G communication network, the number of RBs per channel can range between 1 and 110. Generally, the number of RBs (and the TBS sizes) are expected to grow for 6G and beyond.

In some cases, the system 100 can designate parameters for the gateway 102 and the terminals 106 to communicate with over the satellite communication link. These designated set of parameters may include, for example, a modulation scheme, a coding rate, a transport data block size, a number of resource blocks, and one or more carrier frequencies, in order for these communication devices to understand one another. However, it is often the case that these designated parameters may not be calibrated to ensure a desired system performance is met, which can result in various issues. These issues include, for example, wasteful use of channel capacity that could have been used by other terminals, lost data packets due to path loss, signal quality deterioration due to inefficient transmitter and receiver components, as well as data being received by the gateway with a long delay.

In some implementations, the system 100 can calibrate the communications over the satellite communication link between the terminals 106 and the gateway 102. The system 100 can calibrate the communication in order to compensate for factors that can often otherwise degrade the communications. Such factors include, for example, that the transmitter 112 of terminal 106-1 may exhibit smaller gain at certain SNR ranges than other SNR ranges. Or that the terminal 106-1's transmitter may exhibit jitter that causes the transmitted data to be transmitted at an offset from the expected carrier frequency, causing the gateway 102 to improperly receive the transmitted data over the satellite communication link. Moreover, satellite movement may cause additional path loss when the terminal 106-1 transmits data over the satellite communication link to the gateway. If the gateway 102 is unable to receive the terminal 106-1's transmitted data, then the system 100 may require the terminal 106-1 to repeat transmitting the data, which can exacerbate delays in communication and waste channel bandwidth.

Accordingly, to improve and/or calibrate communications between the terminals 106 and the gateway 102, the system 100 provides a means for selecting communication parameters, e.g., a modulation and coding scheme (MCS), according to a target performance. This target performance or block error rate (BLER) is a performance metrics that refers to a ratio of the number of lost or erroneous blocks to the total number of transmitted blocks in a communication channel. By selecting the communication parameters according to the target performance, the system 100 enables user data to be transmitted at a maximum data rate while maintaining an acceptable BLER according to the selected MCS.

In order for system 100 to select the proper MCS for a terminal and gateway, the system 100 can analyze various factors, such as, for example, allocated resource blocks, a transport block size given to the physical layer allocated to the terminal, whether the payload of the data communications carries Uplink Control Information (UCI), identification of the System Configuration for UCI, e.g., β_{offset}^{HARQ}^{_{ACK}}, β_{offset}^{CQI}^{_{ACK}} factors in the system, whether a burst length of the transmitted data is to be shortened due to the presence of Sounding Reference Signal (SRS) in the system, and practical receiver implementation margin. Not only do these conditions complicate the selection of a proper MCS for various conditions, but they ensure that a wide range of criteria are monitored when selecting the proper MCS. The selection of the MCS according to the target performance will be further described below.

System 100 illustrates various operations in stages (A) through (F). These stages can be performed in the sequence indicated, in another sequence, with fewer stages, or with more stages. The system 100 can also perform other operations in similar stages as those described.

The example of FIG. 1A shows the gateway 102 determining transmission parameters for a terminal to use in making a reverse channel transmission involving uplink from the terminal to the gateway 102. The same techniques can be used to determine parameters for other transmissions, such as a forward channel transmission involving downlink from the gateway 102 to a terminal. As another example, terminals can store lookup tables and determine transmission parameters using the locally stored tables.

During stage (A), the terminal 106-1 can generate communication data 118 to transmit over the satellite communication link to the gateway 102. Here, the link between the terminal 106-1 and the satellite 104 is referred to as the service link. In some cases, the terminal 106-1 may generate the communication data 118 in response to receiving communications from a connected client device. For example, the client device 108-1 may request video data from the internet and provide the request to the terminal 106-1 over a local network. The local network can include Bluetooth, Wi-Fi, ZigBee, or some other short communication medium. The terminal 106-1 has a specific data size it wants to transmit to the gateway 102. The specific data size can be a number of bits or bytes, called the transport block size (TBS). Ultimately, the gateway 102 can allocate a set number of resource blocks for the terminal 106-1 to transmit the specific data size.

Prior to transmitting the requested video data, the terminal 106-1 requires the proper communication parameters to ensure that the client device's 108-1 video data is transported at the maximum data rate while an acceptable error rate is maintained. Accordingly, the terminal 106-1 can generate and transmit a request to the gateway 102 for the proper communication parameters. These proper communication parameters can include, for example, the modulation and coding scheme, a transport block size, and a number of resource blocks. Once the terminal 106-1 has these communication parameters, the terminal 106-1 can prepare the requested video data for transmission using the communication parameters.

To generate the communication data 118, the terminal 106-1 can determine a size of the request from the connected client device. For example, the terminal 106-1 may determine that the connected client device 108-1 requests to transmit a particular amount of data in bits, bytes, or another size, e.g., 1000 bits, over the satellite communication network. The terminal 106-1 can include the determined size of the request from the connected client device in the communication data 118. Additionally, the terminal 106-1 can incorporate data that identifies the terminal 106-1, e.g., a terminal identifier, in order for the gateway 102 to identify the sender of the communication data 118.

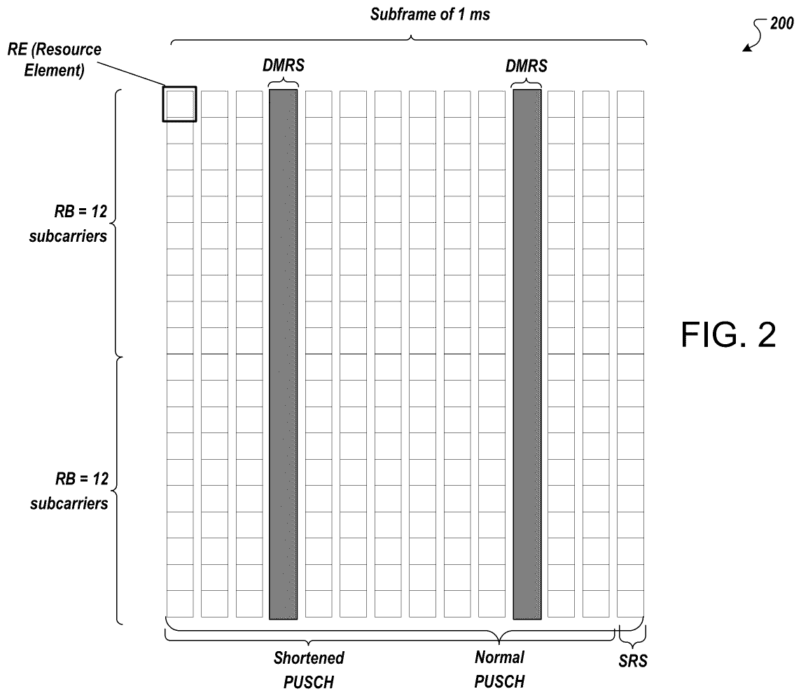

In further detail, the transmitter 112 of terminal 106-1 can include this information in the form of bits or bytes, for example, or provided as a bit stream. The transmitter 112 can include an RF transmit chain, which includes a modulator to determine which modulation scheme is being used or determine the number of bits to be included in each symbol according to the modulation scheme. For example, any of various modulation schemes can be utilized including, for example, BPSK, 8-PSK, QPSK, 16-APSK, 16-QAM, 64-QAM, and 256-QAM, to name some examples. The modulator in the RF transmit chain can generate a modulated signal representing a set of bits according to a modulation scheme. Any appropriate modulator and modulation scheme can be used by each of the RF transmit chains in the system 100. Here, for 5G systems, the modulated signal can be supplied onto carriers of an orthogonal frequency division multiplexing (OFDM) signal and transmitted as a physical uplink shared channel (PUSCH). This is further described below and illustrated with respect to FIG. 2.

In response to modulating, the RF transmit chain can include functions and/or components that prepare the modulated symbols to be transmitted. For example, the RF transmit chain can perform filtering, pulse shaping, pre-equalization, and other features to aid transmission and provide robustness against the effects of the satellite communication link. The RF transmit chain can then upconvert the modulated signal, which is located at an intermediate frequency (IF), to a desired carrier frequency that will be used to transmit the analog signal. Typically, in satellite communications, the carrier frequency is located within higher microwave frequency bands, such as the X frequency band, the Ku frequency band, the K frequency band, the Ka frequency band, or the V frequency band, to name some examples.

The RF transmit chain can include one or more power amplifiers coupled to the transmit antennae. The one or more power amplifiers can amplify the signals to increase the gain of the signal to a desired power level for transmission. The output of the power amplifiers is carried to the antenna. The antenna can transmit a propagating wave 119 associated with the generated communication data 118 to the satellite 104 over the service link.

In some implementations, each of the terminals 106 can include the same components for their respective transmitters. The functionality described above with respect to the transmitter 112 can similarly be performed in each of the other terminals 106. Additionally, the transmission functionality performed by the terminal 106-1 can also be similarly performed by the gateway 102. In some implementations, each of the terminals 106 can perform the same functionality for multiple connected client devices, e.g., terminal 106-N servicing client device 108-N. In this manner, each terminal 106 can service multiple connected client devices and meet the desired criteria for network transfer demands.

During stage, (B), the satellite 104 can receive the propagating wave 119 associated with communication data 118 from the terminal 106-1 and provide the propagating wave 119 associated with the communication data 118 to the gateway 102. The satellite 104 can provide the communication data 118 to the gateway 102 as it receives the communication data from the terminal 106-1, to function as a relay. In some implementations, the satellite 104 can relay communication data received from each of the terminals 106 to the gateway 102. Similarly, the satellite 104 can relay communication data received from the gateway 102 to an intended recipient, e.g., terminal 106-N, as will be further described below.

During stage (C), the gateway 102 can receive the propagating wave 119. In further detail, the receiver 111 of the gateway 102 can receive the propagating wave 119. The receiver 111 can include a single RF receive chain that receives data from the satellite 104. The receiver 111 can include various components to receive and process signals from the satellite 104. For example, the receiver 111 can include an antenna, one or more low noise amplifiers, a downconverter, a demodulator 122, and a decoder 124. The receiver 111 may also include other components such as, for example, one or more pulse shaping filters, one or more bandpass filters, and one or more analog-to-digital converters (ADCs), to name some examples.

In some implementations, the receiver 111 can include one or more antennae that receive the propagating wave 119. The one or more antennae provide signals associated with the received propagated wave 119 to one or more low noise amplifiers (LNAs), that can amplify the signals from the connected antenna feed. In this manner, the LNAs amplify the gain of the received signals, which may have degraded during transmission over the satellite communication link. In response, the LNAs can provide the amplified signal to a downconverter. The downconverter can convert the amplified signals at the carrier frequency to a lower frequency, such as an intermediate frequency. In this manner, subsequent processing performed by the demodulator 122 can be performed at the intermediate frequency or further down at baseband, for example, rather than at the carrier frequency, which requires more processing power. The downconverter can then provide the downconverted signal at baseband to the demodulator 122 for further processing.

In some implementations, the demodulator 122 can receive the downconverted signal from the downconverter. The downconverted signal may be an analog signal. In order for the demodulator 122 to process the received signal, the demodulator 122 may include one or more analog-to-digital converters (ADCs) that can output digital samples corresponding to the analog input signals supplied. The demodulator 122 can process digital samples from ADCs to demap a received symbol to one or more bits, according to the modulation scheme utilized by the transmitter 112 in the terminal 106-1. In further detail, the receiver 111 and the transmitter 112 can use an agreed-upon modulation scheme. For example, as previously mentioned, the modulation scheme can include BPSK, 8-PSK, QPSK, and 64-QAM, to name some examples. The demodulator 122 can receive the digital samples representing a transmitted symbol and output the bits representing the symbol, according to the agreed-upon modulation scheme.

In some implementations, the demodulator 122 can process the received signal in a 5G communication scheme. The received signal can include, for example, encoded PUSCH samples, encoded UCI samples, SRS samples, and RS samples. The demodulator 122 can demodulate the received OFDM signal to extract the PUSCH bits from the encoded PUSCH samples, the UCI bits from the encoded UCI samples, the SRS bits from the SRS samples, and the RS bits from the RS samples. In response, the demodulator 122 can supply the demodulated bits to the decoder 124.

In some implementations, the decoder 124 can include one or more decoders that can process the demodulated bits. In further detail, the decoder 124 can perform a decoding function to recover the original bits that were originally encoded by the one or more encoders of the RF transmit chain 112 of the terminal 106-1, such as the encoding performed by the source and channel encoders. In some examples, the decoder 124 may perform a Viterbi decoding algorithm, decoding using Reed-Solomon codes, and Hamming decoding, to name a few examples. In some examples, the decoder 124 may use low-density parity-check (LDPC), Polar Codes, and Turbo codes. LDPC and Polar Codes are often used in a 5G communication system and Turbo Codes are often used in LTE.

In some implementations, the decoder 124 can include other decoders specific to a 5G communication scheme. These decoders can include, for example, a decoder for the PUSCH decoded bits, a Hybrid Automatic Repeat Request (HARQ) decoder for processing the HARQ decoded bits, and a Channel Quality Indicator (CQI) decoder for processing the CQI decoded bits. In some cases, the quality of the decoded bits can depend on the implementations of the demodulator and decoder pair in a practical receiver at the gateway. In further detail, for a particular resource block amount, the quality of the PUSCH decoded bits depend on a number of factors. These factors include, for example, demodulator type, e.g., QPSK, 16 QAM, or 64 QAM, etc., the number of UCI bits, whether the PUSCH burst is shortened or of normal length, and the algorithms implemented by the receiver 111.

Under different channel conditions, the system 100 should be able to provide the desired quality for the number of bits to transmit provided by the terminal, e.g., terminal 106-1, to the gateway 102. The desired quality can be measured, for example, using a block error rate of the PUSCH decoded bits or some other error rate. In order to meet the desired quality or target performance, the gateway 102 can provide a means for selecting a modulation and coding scheme (MCS), a transport block size (TBS), and a number of resource blocks (RBs) for the corresponding to use for subsequent transmissions. However, by adding UCI bits to the PUSCH channel, e.g., adding HARQ Ack and/or CQI bits, the existence of SRS signals, and the type of modulations, to subsequent transmissions, the system performance may change and not meet the target performance necessary. In these examples, the gateway 102 can adjust the combination of MCS, TBS, and number of RBs for the respective terminal as desired to ensure the target performance is met.

In some implementations, in response to the decoder 124 decoding the demodulated bits, the gateway 102 can provide the decoded bits to the MCS selection module 120. In further detail, the decoder 124 can provide the PUSCH decoded bits, the HARQ decoded bits, and the CQI decoded bits to the MCS selection module 120. In some cases, the signal may not include UCI or CQI bits. Accordingly, the decoder 124 can provide the available decoded bits to the MCS selection module 120 for further processing.

During stage (D), the MCS selection module 120 can analyze various data components associated with the decoded bits to select a suitable MCS, number of RBs, and TBS for the terminal 106-1 that communicates with the gateway 102. In some implementations, the MCS selection module 120 can execute the selection algorithm 121 to identify the suitable MCS, number of RBs, and TBS or perform a lookup for the suitable MCS, number of RBs, and TBS using a Look Up Table (LUT) that was generated previously.

Generally, the MCS selection module 120 can be configured to determine communication parameters for the communications of a particular terminal to the gateway 102 while maintain a target BLER. Here, the MCS selection module 102 can determine communication parameters for the terminal 106-1 to communicate with gateway 102 over the satellite communication link. In some cases, one goal for the MCS selection module 120 is to select the communication parameters, e.g., MCS, number of RBs, and TBS, which minimizes the amount of the resource blocks used, and thus minimized the amount of frequency bandwidth used. The MCS selection module 120 can select an amount of resource blocks that ensures bandwidth is not wasted, other terminals can still be allocated with bandwidth, and the requesting terminal can transmit data at a maximum data rate while maintaining the target BLER.

Moreover, the MCS selection module 120 can attempt to identify communication parameters that not only minimizes the amount of resource blocks but also maximizes throughput from the terminal to the gateway 102. However, if the MCS selection module 120 selects an MCS that is too high, then the target BLER may not be met for the current communication parameters. As the MCS selection module 120 selects a higher MCS, more data is transmitted by the terminal for a given bandwidth, which in turn indicates a smaller number of resource blocks. Accordingly, the MCS selection module 120 ensures that the selected MCS does not exceed the target BLER for a current modulation scheme.

Additionally, the MCS selection module 120 seeks to select communication parameters that is possible for the system 100 to maintain. For example, if the MCS selection module 120 selects a TBS or MCS without taking into consideration one of the other facts, e.g., number of RBs, then the SNR for a target BLER may not be possible, which may require the terminal to retransmit data in the event of data loss or one or more frame errors, which can cause further delays and create problems for the connected client device communicating with the terminal. Accordingly, the MCS selection module 120 can analyze and balance competing constraints to select the proper communication parameters that satisfies the target BLER performance while maximizing throughput and minimizing the usage of resource blocks.

In some cases, the MCS selection module 120 can execute the selection algorithm 121 in real-time or substantial real-time to identify the suitable communication parameters. In this instance, upon the terminal transmitting a request for the amount of data to send, the MCS selection module 120 can use a received SNR estimation and the available number of resource blocks to identify the suitable communication parameters for the terminal to subsequently transmit.

In some cases, the MCS selection module 120 or another system can execute the selection algorithm 121 in advance to generate LUTs that specify different communication parameters for different situations. In many cases, a separate server system or other server system performs the computations to generate the LUTs, and the MCS selection module 120 can receive and store the LUTs for use in selecting communication parameters. For example, to generate the LUTs, the MCS selection module 120 or another system can execute the selection algorithm 121 for a variety of SNR values with respect to a variety of RB amounts to identify MCS values for different combinations of SNR values and RB amounts. The LUTs are multi-dimensional MCS tables indexed by corresponding SNR and RB values. In other words, an SNR value and an RB amount can serve as index values to specify an entry that specifies one or more corresponding parameter values (e.g., modulation, coding, etc.). Multiple LUTs can be used, for example, one for each of different terminal hardware types or terminal product models. In this manner, the LUT for the terminal type or terminal product model can be used to tailor the parameter selection for the device's characteristics. The LUTs can specify an MCS for each of a range of SNR values, showing incremental changes in MCS as the value of SNR changes. By using a LUT (or multiple LUTs for different device types or scenarios), the gateway 102 can perform a fast lookup to select an MCS value for an identified set of SNR and RB values, which avoids the computational burden on the gateway 102 of having to execute the selection algorithm 121.

In further detail, the MCS selection module 120 can execute one or more selection algorithms that accurately select the MCS, number of RBs, and TBS in the presence of UCI and SRS under any given channel condition, e.g., SNR amount. The MCS selection module 120 analyzes a variety of inputs to arrive at the MCS, number of RBs, and TBS that meets the target performance. For example, as illustrated in system 100, the MCS selection module 120 provides the following inputs to the selection algorithm 121: the system information 126, the desired data size 128, the number of available RBs 130, the target BLER 132, the channel condition 134, and the receiver data 136. Other inputs may also be provided to the selection algorithm 121.

In some implementations, the system information 126 can include data that describes the components of the received PUSCH decoded bits. In some cases, the received PUSCH decoded bits can include Uplink Control Information (UCI) and Sound Recording Signal (SRS) signal. The UCI can often include acknowledgement information in the form of Hybrid Automatic Repeat Request Acknowledgement (HARQ-ACK), Scheduling Request (SR) information, and Channel State Information (CSI). The HARQ-ACK information indicated whether a transmitted data packet was successfully received by the gateway 102. The CSI information provides information about the current channel conditions including, for example, signal quality, interference, and other relevant channel parameters. For example, the bit structure of CSI can be identified and found in the system information 126. The SR information is a request from the terminal for uplink resources. The system information 126 can also define whether the presence of UCI is in the decoded PUSCH bits, based on an agreement between the terminal and the gateway 102 prior to the communication.

In some cases, the system information 126 can indicate whether the decoded PUSCH bits includes SRS. In some cases, the SRS can serve as a reference signal transmitted by the corresponding terminal to the gateway. The purpose of SRS is to provide channel state information (CSI) feedback to the gateway 102. By providing the CSI to the gateway 102 in the form of SRS, the gateway 102 can estimate the quality of the satellite communication channel for various frequency regions. However, if the request transmitted by the terminal does include SRS, the SRS can utilize a portion of the transmitted symbols, which reduces the amount of payload from the transmitted symbols that can be transmitted from the terminal to the gateway. This will be further described below.

In some cases, the desired data size 128 can represent the size of data the terminal 106-1 seeks to transmit to the gateway 102. The desired data size 128 can be represented in the form of bits, bytes, or another value. For example, the gateway 102 can determine the desired data size 128 according to a particular bit field in the decoded PUSCH bits. The desired data size 128 may be a size for one transmission or a size for a set number of subsequent transmissions. For example, the desired data size 128 may be 1000 bits.

In some implementations, the available resource blocks 130 can represent the number of resource blocks available by the gateway 102 to provide to a respective terminal. In further detail, the resource blocks define the available bandwidth for terminal transmission or amount of available frequency for a terminal to transmit data. The gateway 102 can track the amount of bandwidth available by monitoring the maximum amount of bandwidth available for the satellite communication link and the amount of bandwidth provided to other terminals 106 for transmission. Based on the difference between the maximum amount of bandwidth available and the amount of bandwidth provided to the other terminals 106, the gateway 102 can determine the available resource blocks 130 or bandwidth for the particular terminal, e.g., terminal 106-1.

In some implementations, the target BLER 132 can represent the target error rate for the PUSCH decoded bits. The target BLER can describe a performance metric to evaluate the quality of data transmission, which likely indicates whether a satellite communication link is coordinated or uncoordinated between the gateway 102 and the terminal 106-1. In some cases, the target BLER 132 can be defined by the terminal that transmitted the communication data 118. In some cases, the target BLER 132 can be defined by a designer of system 100. In some cases, the target BLER 132 can initially be set to a particular value, e.g., 10⁻³, and later adjusted by a designer or by the gateway 102 if the target BLER is too high to receive proper communication or if the target BLER can be increased.

In some implementations, the channel condition 134 can represent the measured condition of the satellite communication link. The channel condition 134 can represent a measured SNR by the receiver 111 of the gateway 102. For example, the receiver 111 can measure the SNR of the satellite communication link by demodulating the received signal and the demodulating the noise from the received signal and finding a power difference between the two values. The measured SNR value can then be a representation of the channel condition 134, in addition to the CSI and the SRS values.

In some implementations, the receiver data 136 can represent characteristics of the receiver 111 of the gateway 102. These characteristics can represent data that models the performance of the receiver 111 across different SNR values. These models can include, for example, mathematical relationships, simulated models, statistical values, and power gain values that describe the receiver 111's performance across different SNR values. As will be further described below, the practical performance of the receiver data 136 can be measured prior to the implementation of the receiver 111 in the gateway 102.

In some implementations, MCS selection module 120 can provide each of the data inputs into the selection algorithm 121. As will be further described below, the selection algorithm 121 can be an iterative algorithm that searches for the suitable MCS, TBS, and number of RBs that satisfy the target BLER 132. In some cases, the selection algorithm 121 can include a trained machine learning model that is configured to output a respective MCS given the provided inputs of system information 126, desired data size 128, available RBs 130, target BLER 132, channel condition 134, and the receiver data 136. For example, if the trained machine learning model outputs an MCS for the corresponding request provided by a respective terminal, the MCS selection module 120 can identify the TBS and corresponding RBs according to a relationship between MCS and TBS. In particular, a relationship exists between the MCS and the TBS for each communication scheme, e.g., 4G, 5G, and 6G. In this case, from the identified MCS, the MCS selection module 120 can identify the corresponding modulation scheme for the terminal and a respective TBS index. The respective TBS index can be used to identify one or more transport block sizes according to the available RBs. In this manner, the MCS selection module 120 can select the TBS according to the minimum number of bits that is required to meet the desired data size 128. By selecting a certain number of RBs that can meet the desired data size 128, the gateway 102 can ensure the terminal 106-1 will receive the proper communication parameters. This will be further shown in equation (1) below.

In some implementations, the MCS selection module 120 may create a table that stores the MCS values for a corresponding SNR and number of RBs. The MCS selection module 120 can create a Look Up Table (LUT) for selecting an MCS value for a respective terminal's subsequent transmission. In some implementations, a server external to the gateway 102 can create the various LUTs. The LUT enables the MCS selection module 120 to select an MCS value for the respective terminal when an SNR value and an available number of RBs. The LUT 138 illustrates a table as an MCS index. Each column in the table represents a different number of RBs. Each row in the table represents different SNR values. The example LUT 138 illustrates the SNRs ranging from 6.4 to 20 and the number of RBs ranging from 1 to 100. Thus, when the SNR is 6.9 dB and the number of RBs is 2, the MCS selection module 120 selects a value of 6 from the LUT 138.

In some cases, the MCS selection module 120 may create multiple LUTs for the receiver 111 of the gateway 102. As will be further described below, the MCS selection module 120 can generate multiple LUTs for the receiver 111 using different PUSCH types, depending on whether the PUSCH carries HARQ ACK-bits, CQI bits, or shortened. In some examples, the MCS selection module 120 can generate 8 LUTs for the receiver 111. In this manner, the MCS selection module 120 can efficiently and quickly identify a LUT that corresponds to the requirements of the PUSCH provided by the terminal and select the MCS from the identified LUT. Depending on the implementation, the MCS selection module 120 can either execute the selection algorithm 121 to identify an MCS, TBS, and number of RBs for the terminal requesting communication parameters or identify an MCS from the corresponding LUT 138.

In some implementations, the MCS selection module 120 can store in memory data that tracks the MCS, the TBS, and the number of RBs selected for a particular terminal. This data the tracks the MCS selection module 120's selection can indicate whether the selected communicated parameters apply for one subsequent transmission by the particular terminal, for N subsequent transmissions by the particular terminal, or to continue for subsequent transmission by the particular terminal until the gateway 102 designates a new communication parameter set for the particular terminal. As an example, the gateway 102 can store data that indicates the MCS, TBS, and number of RBs for terminal 106-1 is MCS of code “6,” a number of RBs of 12, and a TBS of 1000 bits. As another example, the gateway 102 can store data that indicates the MCS, TBS, and number of RBs for terminal 106-N to be MCS of code “8,” a number of RBs of 11, and a TBS of 2000 bits. The gateway 102 can indicate different durations of time that the communication parameters should be used, such as that the communication parameters for terminal 106-1 is only for the next subsequent transmission and the communication parameters for terminal 106-N lasts for the next five transmissions. Other examples are also possible.

As illustrated in system 100, the MCS selection module 120 determines the communication parameters 140 for terminal 106-1 in response to executing the selection algorithm 121 or performing a lookup on the LUT 138. For example, the MCS selection module 120 determines the MCS to be 6, the number of RBs to be 11, and the TBS to be 1000 bits. In some examples, the MCS of 6 corresponds to a modulation scheme of 16 QAM and a coding rate of ½. The gateway 102 can prepare to transmit the communication parameters 140 to the terminal 106-1.

During stage (E), the gateway 102 can include a transmitter 113 that can transmit data over satellite 104 to a respective terminal. The transmitter 113 includes an RF transmit chain similar to the RF transmit chain in the transmitter 112 of the terminal 106-1. For example, the transmitter 113 can receive the communication parameters 140 in the form of bits or bytes and modulate the set of bits according to the agreed upon modulation scheme between the transmitter 113 and the receiver 110. Then, the transmitter 113 can perform filtering, pulse-shaping, pre-equalization, upconverting the modulated signal to a carrier frequency, and providing the upconverted signal to one or more power amplifiers. In response, the one or more power amplifiers amplify the upconverted signal, and provide the signal to an antenna that transmits a propagating wave 141 associated with the communication parameters 140 to the satellite 104.

During stage (F), the satellite 104 can receive the propagating wave 141 from the gateway 102 and relays the propagating wave 141 to the corresponding terminal 106-1. In some implementations, the satellite 104 may include circuitry to demodulate and process a portion of the propagating wave 141 to determine a destination for the propagating wave 141. For example, the satellite 104 may demodulate a portion of the received propagating wave 141 to determine one or more bits in a header of the data indicate the intended recipient is the terminal 106-1.

In some implementations, the terminal 106-1 can receive the propagating wave 141 from the satellite 104. In further detail, the receiver 110 can receive the propagating wave 119 and utilize a single RF receive chain to process signals extracted from the propagating wave 119. The receiver 110 includes similar components and performs similar functionality as the receiver 111 of the gateway 102 and will not be redescribed here. The receiver 110 can extract the decoded PUSCH bits from the propagating wave 119 and determine the communication parameters 140 from the decoded PUSCH bits. The terminal 106-1 can then apply the determined communication parameters 140 to the transmitter 112.

For example, the terminal 106-1 can set the modulation scheme to be 16 QAM according to the MCS corresponding to code “6,” set the number of RBs for subsequent transmission to be 12, and set the transport block size to be 1000 bits for the terminal 106-1's subsequent transmission. Then, the transmitter 112 can transmit the requested video data provided by the client device 108-1 to the gateway 102 through the satellite 104 using the newly set communication parameters 140 provided by the gateway 102. A similar process occurs for the gateway 102's communication with the terminal 106-N.

In some implementations, the MCS selection module 120 may deploy the generated LUTs 138 to each of the terminals 106. In some cases, each of the receivers in each terminal can include a channel SNR estimation module. The channel SNR estimation module, which can include software or hardware components, can determine the SNR and provide the SNR as an input to the selection algorithm 121 or to a corresponding LUT for identifying the MCS parameters. In this manner, each of the terminals 106 can select the communication parameters using a particular LUT according to the criteria of the PUSCH message to be sent and data identifying the receiver 111 at the gateway 102. By incorporating the LUTs 138 at the terminal side, the terminals 106 can more quickly identify the MCS, TBS, and RB parameters than having to transmit a request to the gateway 102 for the communication parameters, which may incur more delay. This can be especially important in cases where the client's request for data is of high priority, e.g., video request or interactive feedback requests.

In some implementations, the system 100 illustrates the gateway 102 and the terminals 106 operating in a return direction. For example, in the return direction, terminal 106-1 transmits communication data 118 to the gateway 102. The gateway 102 measures the received signal SNR from the received communication data 118. In response, using the MCS selection module 120, the gateway 102 selects the suitable communication parameters, e.g., MCS, TBS, and number of RBs, which meets the target BLER for the corresponding terminal 106-1. However, the system 100 also works in the forward direction as well. In the forward direction, the gateway 102 can transmit a request to a terminal, e.g., terminal 106-1, for the channel condition information. In response, the terminal 106-1, for example, can report the downlink channel condition to the gateway 102 through either SNR measurement or by sending the Channel Quality Indicator (CQI) through the PUSCH channel.

In some implementations, the system 100 can be performed using a regenerative payload system onboard the satellite 104 and a corresponding terminal. In further detail, the algorithms and hardware components of the receiver 111 of the gateway, a transmitter, and the MCS selection module 120 may be included in the satellite 104. In this instance, a particular terminal and the satellite 104 may communicate and work collectively to identify the suitable communication parameters for the particular terminal. In the return direction, the particular terminal can transmit a request, such as communication data 118, to the gateway 102 through the satellite 104. The satellite 104 can receive the communication data 118 and measure the received signal SNR of the received communication data 118. The satellite can utilize the components of the MCS selection module 120 to either execute the selection algorithm 121 to identify the suitable communication parameters that meets the target BLER or identify the suitable communication parameters using a corresponding LUT. In this instance, the satellite 104 may be informed of the target BLER by the gateway 102 or by a designer of system 100. In response to identifying the suitable communication parameters, the satellite 104 can transmit the suitable communication parameters to the particular terminal for the particular terminal to transmit subsequent transmissions to a particular gateway.

In some implementations, the satellite 104 and each of the terminals 106 can function as the regenerative payload satellite system in the forward direction. In the forward direction, the satellite 104 can transmit a request to a particular terminal, e.g., terminal 106-1, for the channel condition information. In response, the particular terminal, e.g., terminal 106-1, can report the downlink channel condition to the satellite 104 through either SNR measurement or by sending the CQI through the PUSCH channel. The satellite 104 can utilize the reported SNR from the particular terminal, or the satellite 104 can generate the SNR from the reported CQI. In some cases, the satellite 104 and each of the terminals 106 can include a mapping table that maps the CQI to SNR and use data in the payload of a message to determine the SNR. For example, a CQI of 9 corresponds to an SNR of 6 dB and a CQI of 10 corresponds to an SNR of 7 dB. Other examples are also possible. The mapping table can be pre-computed on the ground, e.g., by a gateway, and provided to the satellite 104 and each of the terminals 106. In some cases, during operation, the gateway can incorporate updated mapping tables in the payload of a message provided to the satellite 104 and each of the terminals 106 to replace their current mapping tables with the updated mapping tables.

Then, the satellite 104 can execute either the selection algorithm 121 or perform a lookup using a corresponding LUT for the receiver of the gateway 102 to identify the corresponding communication parameters for the particular terminal to use for subsequent transmissions to the gateway through the satellite 104.

In some implementations, the system 100 can be performed using a regenerative payload system onboard the satellite 104 and corresponding gateway. Here, a particular gateway and the satellite 104 may communicate and work collectively to identify the suitable communication parameters for the particular gateway. In the return direction, the satellite 104 can transmit a request to the gateway for suitable communication parameters. The gateway can receive the request and measure the received signal SNR of the received request. The gateway can either execute the selection algorithm 121 or perform a lookup using a corresponding LUT to identify the suitable communication parameters that meets the target BLER. In response, the gateway can provide the identified communication parameters to the satellite 104. In some cases, the satellite 104 can allocate the identified communication parameters to the terminal the next time a terminal transmits a request for communication parameters. In some cases, the satellite may provide the suitable communication parameters to a terminal that previously requested for the communication parameters.

In some implementations, the satellite 104 can include a regenerative payload and work with each of the gateways in the forward direction. In the forward direction, the gateway can transmit a request to the satellite 104 for the channel condition information. In response, the satellite can report the downlink channel condition to the gateway through either SNR measurement or by sending the CQI through the PUSCH channel. The gateway can utilize either the reported SNR or can generate the SNR from the reported CQI. Then, the gateway can execute either the selection algorithm 121 or perform a lookup using a corresponding LUT for the receiver of the gateway to identify the corresponding communication parameters for a particular terminal to use for subsequent transmission to the gateway through the satellite 104. In response, the gateway can transmit the suitable communication parameters to the terminal through the satellite 104.

FIG. 1B is a diagram that shows an example of a system 100 for generating a lookup table used for selecting communication parameters. In some implementations, the external server 103 can generate a lookup table that indexes communication parameters, e.g., modulation and coding schemes, by available resource blocks and signal-to-noise ratio values. The external server 103 can generate the lookup table or multiple lookup tables for a receiver at each gateway, as each receiver includes its own performance characteristics. Here, the system 100 illustrates various operation in stages (A′) through (F′). These stages can be performed in the sequence indicated, in another sequence, with fewer stages, or with more stages.

In some implementations, the external server 103 can generate a lookup table for a particular receiver using the characteristics of the particular receiver. In further detail, the external server 103 can measure characteristics of the particular receiver across various signal-to-noise ratio values. Using these characteristics, the external server 103 can approximate the receiver's characteristics using a linear or non-linear function to model the receiver's performance. For example, the server 103 can perform a linear regression or other type of regression to characterize the communication performance over a range of values of various factors, such as one or more linear segments that approximate a relationship between estimated achievable rate of communication across a range of SNR values. Based on the approximated function that models the receiver's performance, the external server 103 can generate one or more lookup tables for the receiver and can deploy the one or more lookup tables to the gateway of the corresponding receiver over the satellite communication network. In some implementations, the process performed with respect to FIG. 1B can also be performed at the corresponding gateway.

During stage (A), in order to model the performance of the gateway's receiver, the external server 103 can obtain receiver performance across different SNR values. The external server 103 can initially measure the performance of the receiver. In order to measure the performance, the external server 103 can determine one or more optimization metrics for the receiver of the gateway. The one or more optimization metrics can include, for example, an effective coding rate and an achievable effective rate. For a particular combination of values for MCS, TBS, and number of RBs, the performance, e.g., the BLER of a PUSCH, of the receiver at the gateway is a function of the effective coding rate. The effective coding rate is defined as shown in equation (1) below.

$$ER = \frac{PUSCH bits}{Transmitted Bits} = \frac{TBS + CRC}{RB * {N}_{SYM} * {M}_{mod} * {N}_{SC} - UCI} \qquad ( 1 )$$

As shown in equation (1), the effective coding rate represents the number of bits output from the decoder divided by the number of bits received by the gateway 102. The effective coding rate can depend on the existence of the UCI bits in the PUSCH data stream and the SRS in the PUSCH data stream. These added bits, e.g., UCI bits, SRS, etc., increase the effective coding rate for the decoder in the receiver of the gateway and can cause degradation to the overall performance of the PUSCH transmission. In equation (1), TBS corresponds to the size of data blocks in bits, which is fixed for each MCS and CRC corresponds to the number of bits in the cyclic redundancy check (CRC). N_{SYM} is the number of symbols in a subframe of the PUSCH data stream. The number of symbols can be 12 for a regular PUSCH subframe or 11 for a shortened PUSCH subframe. M_{mod} is the number of bits per modulation scheme or per symbol, e.g., QPSK=2 bits, 8−PSK=3 bits, 16 QAM=4 bits, to name a few examples. N_{SC} is the number of subcarriers. RB is the number of resource blocks. UCI is the number of bits used for Uplink Control Information, which depends on the terminal and can be found in the PUSCH bit stream. In further detail, the UCI consists of CQI bits and HARQ-ACK bits and UCI depends on the selection of MCS. Moreover, the UCI depends on a β value for CQI and HARQ-ACK or system configuration. The β value represents the resolution of the UCI—the higher the β values, the more bits that will be taken from the payload of the PUSCH.

The effective coding rate can change according to the number of UCI information included in the PUSCH bit stream, which is typically agreed upon between the terminals 106 and the gateway 102. For example, the more UCI information included in the PUSCH channel, the higher the effective coding rate. Likewise, the less UCI information included in the PUSCH bit stream, the lower the effective coding rate. Generally, for a fixed number of resource blocks, the quality or performance of the PUSCH depends on the modulation scheme, e.g., QPSK, 8PSK, or 16-PSK, for example, and the number of UCI bits. Moreover, a block can be defined as 1 PUSCH block or a TBS, and the TBS is an input to the physical layer. For example, for many different combinations of (i) a number of RBs and (ii) a SNR value, there is a maximum effective coding rate that satisfies the criteria for a target error rate or maximum error rate, such as BLER≤10⁻³. This maximum effective coding rate that satisfies a targeted block error rate criteria is known as the Achievable Effective Rate (AER). The AER can be defined in the following equation (2) shown below:

$$AER = MAX ( ER ) , such that BLER \leq {10}^{- 3} \qquad ( 2 )$$

Equation (2) shows the Achievable Effective Rate as the maximum effective coding rate such that the block error rate is less than or equal to 10⁻³. The AER is a measure of performance for the receiver of the gateway and describes the maximum rate available while the block error rate remains less than or equal to a desired or target error rate. However, equation (2) may use other block error rates, such as 10⁻⁴, 10⁻⁵, or another error threshold. Accordingly, if the performance criteria of a PUSCH is set to be BLER≤10⁻³, then for every combination of RB amount, MCS, UCI, or SRS, there exists a minimum SNR that satisfies the BLER≤10⁻³ requirement. For example, FIG. 1C illustrates an example of a graph that displays receiver performance across different SNR values. In further detail, FIG. 1C displays for any particular number of RBs, the performance curves of various combinations of all MCS types, e.g., different TBS sizes, different UCIs, SRS, worsen as the effective coding rate increases.

For example, FIG. 1C shows example performance curves of a practical receiver utilized at the gateway 102. The communication parameters set for the receiver include RB=10, MCS=8, and TBS=1384. The performance curves show the effect of different UCI/SRS combinations across varying SNR values. The table (1) shown below illustrates the effects of adding different UCI and SRS signals to the Achievable Effective Rate. For instance, the number of PUSCH encoded bits includes 12*10*2*12=2880 and the number of PUSCH encoded bits with SRS=12*10*2*11=2640, where the UCI bits consist of CQI bits and HARQ bits. The values that define UCI include, for example, Q_{ACK} (β_{ACK}=14)=238 and Q_{CQI}(B_{CQI}=14)=48. In some cases, the HARQ ACK and CQI can carry control bits, and these bits carry data that have to meet a minimum performance target requirement for reliability, such as false detection performance of less than 10⁻³, and miss detection performance of less than 10⁻³. Other examples are also possible. The false detection performance and the miss detection performance are a function of SNR and a number of these bits. The number of HARQ ACK bits, e.g., Q_{ACK}, and the number of CQI bits, e.g., Q_{CQI}, are pre-calculated and tabulated for different SNR values at a desired target performance. The entries in table 1 shown below are indexed by the beta values.

TABLE 1
AER values for different combinations of MCSs for receiver in FIG. 1C

| | | | | | | | | PUSCH + |
|---|---|---|---|---|---|---|---|---|
| | | | | PUSCH + | | PUSCH + | PUSCH + | SRS + |
| | | PUSCH + | PUSCH + | CQI + | PUSCH + | SRS + | SRS + | CQI + |
| | PUSCH | CQI | HARQ | HARQ | SRS | CQI | HARQ | HARQ |
| AER | 0.489 | 0.498 | 0.537 | 0.548 | 0.533 | 0.543 | 0.586 | 0.598 |
| SNR | 1.9 | 2.00 | 2.5 | 2.6 | 2.3 | 2.5 | 3.2 | 3.3 |
| @ | | | | | | | | |
| BLER = | | | | | | | | |
| 10⁻³ | | | | | | | | |

Accordingly, as shown in FIGS. 1C and 1n Table 1, as more UCI and SRS information is included in the PUSCH data stream, the gateway 102 and the corresponding terminal require transmitting at a higher SNR to maintain the target BLER.

Returning to FIG. 1B, during stage (B′), the external server 103 can estimate the achievable effective rate based on the measured performance of the receiver. In further detail, the external server 103 estimates the achievable effective rate for each of the possible RB amount, MCS, and TBS combinations, including each permutation of including SRS and UCI information in the MCS, RB amount, and TBS combination. In this manner, the external server 103 can model how the receiver achieves the maximum effective coding rate while maintain the target BLER across different SNR values.

FIG. 1D is an example graph that displays achievable effective rate performance for the measured receiver at the gateway 102 across various SNR values. As illustrated in FIG. 1D, the external server 103 can display the achievable effective rates for the measured receiver and group or cluster the achievable effective rates according to designated MCSs. For example, as illustrated in FIG. 1D, the external server 103 can group a first set of achievable effective rates for MCSs ranging from 0 to 11, a second set of achievable rates for MCSs ranging from 12 to 17, and a third set of achievable rates for MCSs ranging from 24 to 25. Here, a value of 0 for MCS to a value of 11 for MCS corresponds to QPSK; a value of 12 for MCS to a value of 17 for MCS corresponds to 8-PSK; and, a value of 24 for MCS to a value of 25 for MCS corresponds to low QPSK. The external server 103 can model receiver's performance using the grouped achievable effective rates.

Returning to FIG. 1B, during stage (C′), the external server 103 can approximate a relationship between the SNR values and the achievable effective rates using the grouped achievable effective rates. Generally, the external server 103 can generate a relationship between the SNR values and the achievable effective rates using the grouped achievable effective rates. In the example of FIG. 1E, the external server 103 can perform a linear estimation of each of three sets of achievable effective rates. In some examples, the external server 103 can apply a linear mean square error (MSE) algorithm to the grouped achievable effective rates. The external server 103 can apply the linear MSE algorithm to draw a line connecting the SNR values and corresponding achievable effective rates for each of set of the achievable effective rates. For example, the linear estimation 143 corresponds to the MCSs 24 and 25, the linear estimation 145 corresponds to the MCSs 0 to 11, and the linear estimation 147 corresponds to the MCSs 12 to 17.

Returning to FIG. 1B, during stage (D′), the external server 103 can generate characteristics of the approximated SNR and the achievable effective rate relationships. In further detail, the external server 103 can analyze the linear estimation of each of the three sets of achievable effective rates and characterize the linear estimation for each of the three sets of achievable effective rates. In the example of FIG. 1F, the external server 103 can analyze the linear estimation 143, the linear estimation 145, and the linear estimation 147, and develop characteristics for each of these linear estimations. The external server 103 can measure a slope and a Y-intercept of each of the linear estimations, for example, and model equations for each of the three estimations.

In some examples, the external server 103 determines an equation (3) for the linear estimation 143, shown below. Equation (3) is determined according to the slope and the Y-intercept for linear estimation 143.

$${AER}_{QPSK} = {α}_{1} * SNR + {β}_{1} \qquad ( 3 )$$

In some examples, the external server 103 determines and equation (4) for the linear estimation 145, shown below.

$${AER}_{8 PSK} = {α}_{2} * SNR + {β}_{2} \qquad ( 4 )$$

In some examples, the external server 103 determines and equation (4) for the linear estimation 147, shown below.

$${AER}_{LOW QPSK} = {α}_{3} * SNR + {β}_{3} \qquad ( 5 )$$

The external server 103 can use equations 3, 4, and 5 to determine the achievable effective rates for each of the linear estimations according to an SNR value. Moreover, the values α₁, α₂, α₃, β₁, β₂, β₃ are different for each RB value that is different. In some examples, the performance curves shown in FIGS. 1C-IF show communication data when Additive White Gaussian Noise (AWGN) is present, but the system 100 can be expanded to other types of noise and other modulation types, such as, 16 QAM, 64 QAM, and 256 QAM, to name some examples. In some examples, the linear estimations can be straight lines. In some examples, these estimations may be curved lines, such as a quadratic line, or another type of line.

Returning to FIG. 1B, during stage (E′), the external server 103 can generate a set of lookup tables (LUTs) for select resource blocks and SNR values using the equations of the linear estimations. In order to generate the LUTs for the receiver, the external server 103 can analyze the criteria of the achievable effective rates. First, the achievable effective rate has an estimated linear relationship with the SNR values, as shown in FIGS. 1C through IF. Second, the achievable effective rate can be defined according to the selected number of RBs, TBS, MCS, UCI, and SRS values. Third, the achievable effective rate is measure of the performance of the PUSCH as supported by the practical receiver data. In some examples, the external server 103 can set a target BLER of 10⁻³. Alternatively, the external server 103 can set other target BLER values, such as 10⁻⁴, 10⁻⁵, or another threshold level, as specified by an implementer of system 100 or as appropriate to meet the performance constraints of the system 100.

In order to generate the series of LUTs, the external server 103 can execute the selection algorithm 121 that considers the criteria of the achievable effective rates and the data inputs provided from a terminal. In particular, in the example of FIG. 1G, the external server can generate the one or more LUTs for a range of RB amounts and a range of SNR values. The selection algorithm 121 can receive as input, for example, the system information 126, the desired data size 128, the available RBs 130, the target BLER 132, the measured SNR/channel condition 134, and the practical receiver performance data 136. As previously described, the system information 126 can include system configuration for UCI, presence of UCI, and data representing the SRS signal.

In some implementations, the selection algorithm 121 can include a multistage process that seeks to identify the lowest RB or the highest MCS for the terminal to transmit data such that the target BLER at the receiver of the gateway is satisfied. Moreover, the selection algorithm can be divided into two stages. In the first stage, the selection algorithm 121 attempts to identify the lowest possible RB and the highest possible MCS for a known SNR and TBS for the terminal. For example, FIG. 1H illustrates an example of the first stage of the sub-algorithm for selection algorithm 121.

In some implementations, the external server 103 executes the first stage of the algorithm to identify the lowest possible number of RBs for the maximum TBS value that satisfies the target BLER. In further details, the first stage of the algorithm iterates from the lowest RB value available to the maximum RB value available. For each RB value, the external server 103 iterates from the maximum TBS or transport data block size to the desired bits the terminal requests, e.g., BITS_{des}. For each RB value and each TBS value, the external server 103 calculates the achievable effective rate using equation (1). Based on the calculated achievable effective rate value, the external server 103 can calculate a temporary SNR value using equations (3), (4), or (5). The external server 103 can select one of equations (3), (4), or (5) to use for calculating the TmpSNR according to the RB and TBS identified from the first and second for loop values. The external server 103 can determine the MCS based on knowing the RB and TBS, and identify a corresponding modulation from the determined MCS. For example, if the values of RB and TBS correspond to a modulation of QPSK, then the external server 103 can select equation (3) to calculate the TmpSNR. Similarly, if the values of RB and TBS correspond to a modulation of 8PSK, then the external server 103 can select equation (4) to calculate the TmpSNR. Other examples are also possible.

In response to calculating the TmpSNR, the external server 103 can compare the TmpSNR to the received SNR value measured by the receiver of the gateway 102. If the value of TmpSNR is less than the value of the received SNR, then the external server 103 can output the RB, the TBS, and the MCS and cease processing the algorithm. Here, the solution is complete, and the external server 103 can output the communication parameters 140 to an LUT for the receiver. Alternatively, if the external server 103 determines the TmpSNR is greater than or equal to the SNR value, then the external server 103 can iterate a TBS value or iterate the value for the number of RBs, depending on where the algorithm is currently in execution.

For one such example, the table 2 shown below illustrates the results of the first stage of the selection algorithm 121 for a particular example. Specifically, table 2 illustrates that for any given channel SNR and a requested number of bits by the terminal, the lowest RB, e.g., highest MCS, to transmit data from the terminal, such that the block error rate or probability of error at the receiver of the gateway is less than or equal to 10⁻³. Thus, to transmit 1000 bits under the condition of the block error rate being less than or equal to 10⁻³, there are multiple choices shown in the table 2 for different MCS and SNR combinations for a the same SNR value. Note that in this example, the MCS omits the forward error correction coding parameters, but the different MCS codes (e.g., 0, 1, 3, 4, 6, 11) shown below can each include different forward error correction coding parameters to maximize the throughput while still achieving the desired error rate level. In other words, even MCSs that share the same modulation, e.g., QPSK, can differ in the forward error correction coding applied to adjust the throughput and robustness of communication.

TABLE 2
Results of First Stage of Selection Algorithm

| | Minimum SNR | Minimum SNR | | | |
|---|---|---|---|---|---|
| Actual | (No CQI/ | (With CQI/ | No. of | | |
| TBS | HARQ/SRS) | HARQ/SRS) | RBs | MCS | |
| 1096 | −4.2 | −3.4 | 40 | 0 | (QPSK) |
| 1064 | −3.2 | −1.7 | 30 | 1 | (QPSK) |
| 1160 | −1.6 | −1.1 | 20 | 3 | (QPSK) |
| 1064 | −1.0 | −0.1 | 15 | 4 | (QPSK) |
| 1032 | 0.5 | 1.9 | 10 | 6 | (QPSK) |
| 1000 | 5.1 | 9.0 | 5 | 11 | (QPSK) |
| 1000 | 5.1 | 7.5 | 5 | 12 | (8-PSK) |

However, if the external server 103 traverses through each of the TBS values and RB values without finding a TmpSNR value that satisfies the SNR value, then the external server 103 has determined that the terminal cannot send the desired bit amount according to the available resource blocks while meeting the target BLER. Accordingly, the external server 103 can instead enable sending a portion of the desired bit amount while maintaining the desired performance. FIG. 1I illustrates an example of the second stage of the sub-algorithm for selection algorithm 121 if the first stage does not produce communication parameters.

In some implementations, the external server 103 executes the second stage of the algorithm to identify the highest MCS and TBS possible for a known SNR and remaining available resource block amount. Here, the selection algorithm 121 seeks to transmit the maximum amount of data possible using all available RBs while satisfying the target performance conditions. For the second stage, the inputs to the second stage are all available RBs and known SNR value. For example, the selection algorithm 121 can attempt to find the maximum possible TBS for a current SNR—the TBS can carry a partial amount of data that is requested by the terminal using the available RB. However, if the highest MCS cannot be found, the selection algorithm 121 can determine that with the current SNR and the available RB, there are no possible communication parameters available such that the target block error rate is satisfied.

For example, as illustrated in FIG. 1, the external server 103 iterates from the maximum TBS value to the lowest TBS value available using tbs. Based on the tbs value, the external server 103 calculates a temporary achievable effective rate (AERₜₘₚ) using equation (1). Based on the calculated temporary achievable effective rate value, the external server 103 can select one of equations (3), (4), or (5) to calculate an achievable effective rate for a particular modulation (AERₓ) using the known SNR value. For example, the external server 103 can determine which equation to use according to a corresponding modulation from the determined MCS.

In response to calculating the AERₓ, the external server 103 can compare the AERₓ to the AERₜₘₚ. If the external server 103 determines the AERₓ is greater than or equal to the value of AERₜₘₚ, then the external server 103 can output the tbs value as the amount of data the terminal is available to send while still meeting the desired performance. Alternatively, if the external server 103 determines that the AERₓ is less than the AERₜₘₚ, then the external server 103 can iterate to the next tbs value. However, if the external server 103 traverses through each of the tbs values without finding an AERₓ that is greater than or equal to the AERₜₘₚ, then the external server 103 has determined that under the current circumstances, e.g., the current SNR and the RB available, the terminal is unable to send any data while meeting the current performance.

Returning to FIG. 1G, the external server 103 can execute the selection algorithm 121 multiple times to generate lookup tables by iterating from the lowest possible SNR value to the highest possible SNR value in system 100. In some cases, the external server 103 can execute the selection algorithm 121 offline to generate multiple lookup tables for each receiver in a respective gateway. For example, the external server 103 can generate 8 lookup tables for each receiver by executing the algorithm shown in FIGS. 1H and 1I. The 8 lookup tables can be created for the following scenarios: (1) PUSCH frame, (2) PUSCH+CQI frame, (3) PUSCH+HARQ frame, (4) PUSCH+CQI+HARQ frame, (5), PUSCH+SRS frame, (6) PUSCH+SRS+CQI frame, (7) PUSCH+SRS+HARQ frame, and (8) PUSCH+SRS+CQI+HARQ frame. The external server 103 can execute the selection algorithm 121 for each of these 8 different scenarios to generate 8 different lookup tables.

Returning to FIG. 1B, during stage (F′), in response to generating the lookup tables for each gateway of a receiver, the external server 103 can deploy each of the generated lookup tables to each gateway 102-1 through 102-N. For example, the external server 103 can generate LUTs 146 for gateway 102-1, LUTs 148 for gateway 102-2, and LUTs 150 for gateway 102-N. Each of these LUTs may have different MCS values across SNRs and RBs due to performance characteristics of the different receivers located at each of the gateways 102-1 through 102-N. The gateways 102-1 through 102-N can service different terminals and notify the corresponding terminals of communication parameters to use when the terminal desires to communicate with a respective gateway based on the gateway's respective LUTs.

FIG. 2 is a diagram showing an example of symbols transmitted in a physical uplink shared channel (PUSCH) 200. The PUSCH, or physical uplink shared channel, is channel used by the terminal to transmit data to the gateway. The PUSCH 200 can carry data, such as voice, video, or other types of application data. The PUSCH 200 can include various resource blocks within a time-frequency grid for transmission, and the allocation of such RBs for the PUSCH can be dynamically configured based on scheduling decisions and RBs available for the particular terminal. Each resource element can carry two bits for QPSK, three bits for 8-PSK, and 4 bits for 16 QAM, to name some examples. A resource element can represent the smallest resource unit that is defined as one subcarrier in the frequency domain and one OFDM symbol duration in time domain. The resource block or RB is a unit defined over 12 subcarriers in frequency and 14 OFDM symbol duration in time.

In some cases, the PUSCH can include a Demodulation Reference Signal (DRMS). The gateway can use the DRMS in the PUSCH for channel estimation and demodulation reference purposes.

In some cases, the subframe of a PUSCH may include 14 total OFDM symbols. The length of a PUSCH may be 1 millisecond, for example. A normal PUSCH may include 12 data OFDM symbols. A shortened PUSCH may include 11 OFDM symbols, and the 12^{th} symbol, e.g., the 14^{th} column of the PUSCH, may be used for the Sounding Reference Signal (SRS). The SRS is configured across the entire channel band of the PUSCH, which allows the gateway to perform uplink channel estimation over the entire frequency span.

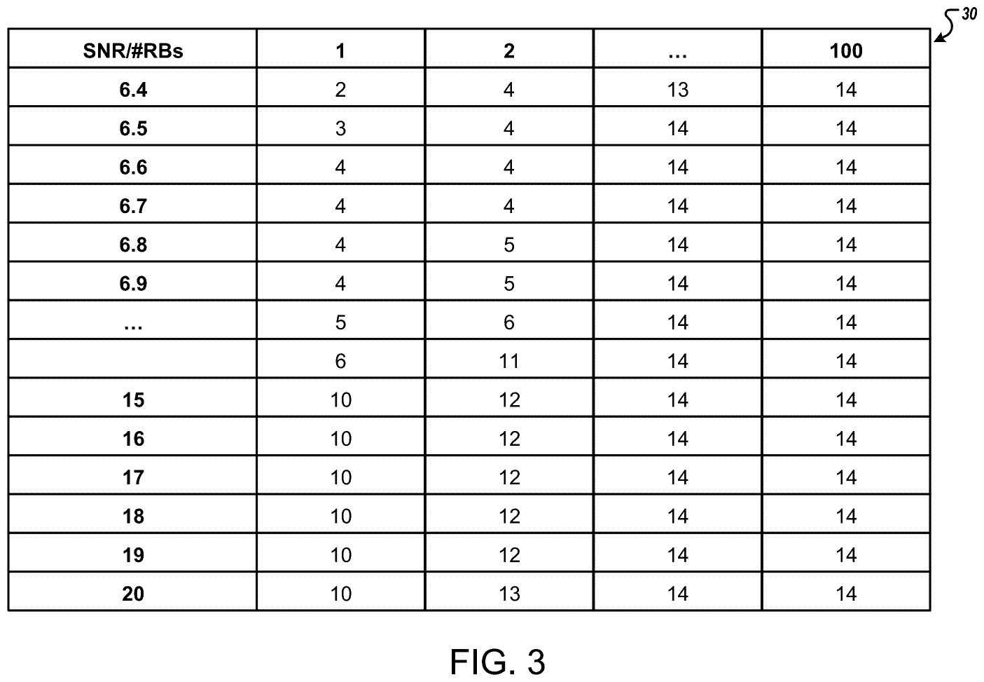

FIG. 3 is a diagram showing an example of a LUT 300 for selecting a modulation and coding scheme. The lookup table 300 illustrates the MCS values according to SNR and a number of RBs. In some cases, an external server can generate one or more LUTs for a gateway. In some cases, the gateway can generate the one or more LUTs for its own use.

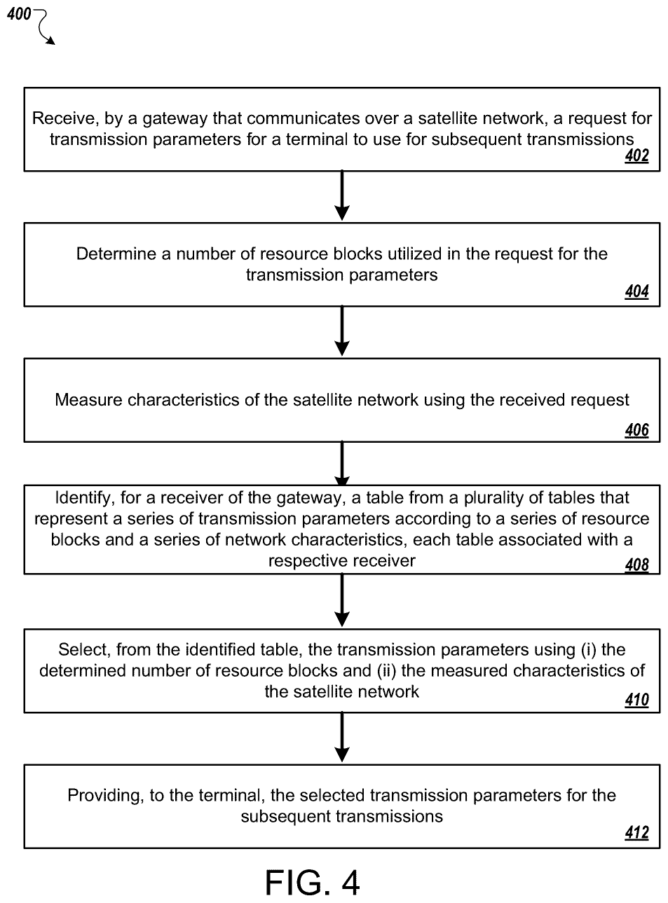

FIG. 4 is a flow diagram that illustrates an example of a process 400 for selecting a modulation coding scheme for a terminal in a satellite communication network. A gateway, such as gateway 102 from system 100, can perform the process 400. Similarly, a satellite, such as satellite 104, or a terminal, such as terminal 108-1, can perform the process 400.

A gateway can receive, over a satellite network, a request for transmission parameters for a terminal to use for subsequent transmissions (402). The gateway can receive the request from a terminal for transmission or communication parameters for the terminal to use for the subsequent transmissions. The communication parameters can include modulation and coding parameters, a transport block size, and a number of resource blocks for the terminal to use for the subsequent transmissions. In some cases, the request for the transmission parameters for the terminal to use can represent a number of bits the terminal desires to transmit to the gateway over the satellite network for the subsequent transmissions. Additionally, based on the request, the gateway can determine the transmission parameters for the terminal to transmit the number of bits such that the gateway is configured to decode the number of bits transmitted according to a desired or target block error rate. In some cases, the target block error rate (e.g., a probability of error) can be defined to be 10⁻³, 10⁻⁴, 10⁻⁵, or another error rate.

The gateway can determine a number of resource blocks utilized in the request for the transmission parameters (404). In further detail, the gateway can demodulate data indicative of the received request according to a modulation and coding scheme utilized by the terminal. In response to demodulating the data, the gateway can extract the number of resource blocks from the demodulated data. For example, the gateway can identify at least one subframe in the demodulated data and detect a number of symbols in the at least one subframe. Based on the detected number of symbols in the at least one subframe, the gateway can determine the number of resource blocks utilized. The at least one subframe may include 14 symbols and include a length of 1 millisecond. Moreover, determining the number of resource blocks can include determining the number of resource blocks in a symbol of the 14 symbols in the at least one subframe. In some cases, the demodulated data can include demodulated OFDM symbols.

In some cases, 12 of the 14 symbols in the at least one subframe can correspond to a normal physical uplink shared channel (PUSCH). In some cases, 11 of the 14 symbols in the at least one subframe can represent a shortened PUSCH, and the remaining 3 symbols can represent sounding information (SRS).

The gateway can measure characteristics of the satellite network using the received request (406). In further detail, the gateway can measure a signal-to-noise ratio (SNR) of a communication quality of the satellite network using the demodulated data indicative of the request received by the gateway. In some cases, the gateway can measure the SNR using payload data or header data in the received request.

The gateway can identify, for a receiver of the gateway, a table from a plurality of tables that represent a series of transmission parameters according to a series of resource blocks and a series of network characteristics, each table associated with a respective receiver (408). In particular, the gateway can select the table from the plurality of tables according to communication parameters. The communication parameters can include, for example, (i) a type of receiver used a gateway, (ii) types of PUSCH utilized in the subsequent transmissions, (iii) whether control bits are included in the subsequent transmissions, and (iv) whether the subsequent transmission include channel quality indicator information. The selected tables can store modulation and coding parameters for the receiver utilized at the gateway and the transmitter utilized at the terminal.

In some cases, prior to identifying the table from the plurality of tables, the gateway can generate each of the tables for the receiver at the gateway for a set of communication parameters. In some cases, each of the tables can be generated by an external server. The tables can be generated by, for example, measuring, for the receiver at the gateway, error rates across a series of signal-to-noise ratio values for a set number of resource blocks and a desired modulation and coding scheme, the measured error rates reflecting a number of lost bits for receiving encoded bits in a PUSCH at the receiver. Then, the gateway can estimate an achievable effective rate of the receiver using the measured error rates. The achievable effective rate can represent a performance of the receiver measured across the series of signal-to-noise ratio values, a plurality of modulation and coding scheme, a plurality of resource blocks, and a plurality of control bits. The gateway can determine, for the receiver, a relationship between the series of signal-to-noise ratio values and the estimated achievable effective rate of the receiver. The gateway can extract characteristics of the determined relationship, the extracted characteristics representing (i) a slope of the determined relationship and (ii) an offset value of the determined relationship. The extracted characteristics can include a linear graphical representation, for example. In response, the gateway can generate, for the receiver, each table of the plurality of tables that represent the series of transmission parameters according to the series of resource blocks and the series of network characteristics using (i) the extracted characteristics of the determined relationship, (ii) the plurality of modulation and coding schemes, (iii) the plurality of resource blocks, and (iv) the communication parameters.

In some implementations, the gateway can generate, for the receiver, a table for a set of communication parameters, by iterating over (i) each resource block in the series of resource block, and (ii) for each resource block, iterating over each transport block size in the series of transport block sizes. Here, the gateway can determine a first achievable effective rate using (i) the transport block size, (ii) the resource block, (iii) a of subcarriers in a subframe, (iv) a number of symbols in the subframe, (v) the plurality of control bits, and (vi) a number of bits in cyclic redundancy check. The plurality of control bits can include, for example, Uplink Control Information (UCI), Sounding Reference Signal (SRS), and Channel Quality Information (CQI). The gateway can determine a temporary SNR value using (i) the determined first achievable effective rate and (ii) the extracted characteristics of the determined relationship. If the determined temporary SNR value is less than an SNR value of the measured characteristics of the satellite network, the gateway can (i) acquire a respective modulation and coding scheme according to the transport block size and the resource block, and (ii) set, as an entry in the table, the acquired modulation and coding scheme based on indexing with the resource block and the determined temporary SNR.

In some cases, in response to determining the temporary SNR is not less than the SNR value of the measured characteristics of the satellite network for each resource block and each transport block size, the gateway can iterate over each transport block size in the series of transport block sizes and perform the following processes. In further detail, the gateway can determine a second achievable effective rate using (i) the transport block size, (ii) the number of bits in the cyclic redundancy check, (iii) an available resource block, (iii) the number of subcarriers in the subframe, and (iv) the plurality of control bits. Then, the gateway can determine a third achievable effective rate using (i) the extracted characteristics of the determined relationship and (ii) an SNR value of the measured characteristics of the satellite network. If the gateway determines the second achievable effective rate satisfies the third achievable effective rate, then the gateway can (i) acquire a respective modulation and coding scheme according to the transport block size and the available resource block and (ii) set, as an entry in the table, the acquired modulation and coding scheme based on indexing with the available resource block and the SNR value of the measured characteristics of the satellite network.

In some cases, the gateway or another system can generate, for the receiver, each table of the plurality of tables that represent the series of transmission parameters by either (i) selecting a modulation and coding scheme and a desired resource block for a known signal to noise ratio value and a transport block size value or (ii) selecting a modulation and coding scheme and a desired transport block size for the known signal to noise ratio value and an available resource block size.

The gateway can select, from the identified table, the transmission parameters using (i) the determined number of resource blocks and (ii) the measured characteristics of the satellite network (410). In some examples, the gateway can select an MCS of 6 for an SNR of 6.9 and a number of RBs of 2.

The gateway can provide, to the terminal, the selected transmission parameters for the subsequent transmissions (412). For example, the gateway can provide the MCS of 6, an RB of 12, and a TBS of 1000 bits to the terminal for the terminal to utilize for subsequent transmissions.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
determining a number of resource blocks to use for one or more communications between a terminal and a gateway in a satellite communication network, wherein the number of resource blocks indicates an amount of frequency bandwidth to use for the one or more communications;
determining a characteristic of a wireless channel used for communication between the terminal and the gateway in the satellite communication network;
selecting a table from a plurality of tables, wherein each of the tables specifies transmission parameters to use for different combinations of (i) values indicating different numbers of resource blocks and (ii) values indicating different wireless channel characteristics;
determining transmission parameters for making the one or more communications between the terminal and the gateway based on an entry, retrieved from the identified table, that corresponds to (i) the determined number of resource blocks and (ii) the determined characteristic of the wireless channel; and
causing one or more transmissions to be sent between the terminal and the gateway using the determined transmission parameters.

2. The computer-implemented method of claim 1, wherein the method is performed by the terminal using tables stored by the terminal.

3. The computer-implemented method of claim 1, wherein the method is performed by the gateway using tables stored by the gateway.

4. The computer-implemented method of claim 1, wherein determining the transmission parameters comprises determining the transmission parameters for a transmission in a forward direction involving downlink from the gateway to the terminal.

5. The computer-implemented method of claim 1, wherein determining the transmission parameters comprises determining the transmission parameters for a transmission in a reverse direction involving uplink from the terminal to the gateway.

6. The computer-implemented method of claim 1, wherein determining the transmission parameters comprises determining, by the gateway, transmission parameters for a subsequent transmission from the terminal to the gateway; and
wherein causing the one or more transmissions to be sent between the terminal and the gateway using the determined transmission parameters comprises transmitting the determined transmission parameters to the terminal over the satellite communication network, such that the terminal transmits the subsequent transmission to the gateway using the determined transmission parameters.

7. The computer-implemented method of claim 1, wherein determining the transmission parameters comprises at least one of (i) determining a modulation or (ii) determining a forward error correction coding.

8. The computer-implemented method of claim 1, wherein the selected table includes entries for each of multiple combinations of a number of resource blocks and a wireless channel characteristic, and the entries each specify transmission parameters that are calculated to provide a same predetermined target error rate for reception of transmissions over the satellite communication network made using the combination corresponding to the entry.

9. The computer-implemented method of claim 1, wherein the entries in the selected table each specify a modulation and coding scheme (MCS) from a predetermined set of MCSs; and
wherein each of the entries in the selected table is set based on a same predetermined target error rate such that each entry specifies the MCS, from among the predetermined set of MCSs, that is calculated to provide an error rate that is closest to the predetermined target error rate or is closest to the predetermined target error rate without exceeding the predetermined target error rate.

10. The computer-implemented method of claim 1, wherein the entries in the selected table each specify a modulation and coding scheme (MCS) from a predetermined set of MCSs; and
wherein each of the entries in the selected table is set based on a same predetermined target error rate such that each entry specifies the MCS, from among the predetermined set of MCSs, that is calculated to maximize throughput over the satellite communication network for communication between the terminal and the gateway without exceeding the target error rate.

11. The computer-implemented method of claim 1, wherein the entries in the selected table each specify a modulation and coding scheme (MCS) from a predetermined set of MCSs; and
wherein the entries in the selected table are set to MCSs, selected from among the predetermined set of MCSs, that are calculated to achieve a same tradeoff between a level of throughput over the satellite communication network and a likelihood that retransmission of a message is needed, wherein the tradeoff is set using a predetermined target error rate.

12. The computer-implemented method of claim 1, wherein the target error rate is a block-level error rate.

13. The computer-implemented method of claim 1, wherein the target error rate is a block-level error rate indicating a frequency or probability with which a transport block or a message transmitted will be received with an uncorrectable error that requires retransmission of the transport block or message.

14. The computer-implemented method of claim 1, wherein entries in the tables specify transmission parameters that include at least one of a modulation or forward error correction coding, and the entries are determined based on analysis of measured performance of actual receivers and/or transmitters transmitting with the transmission parameters specified in the entries.

15. The computer-implemented method of claim 1, wherein determining the characteristic of the wireless channel comprises determining a signal-to-noise ratio (SNR) for the terminal or a signal-to-interference-and-noise ratio (SINR) for the terminal.

16. The computer-implemented method of claim 1, wherein determining the characteristic of the wireless channel comprises determining a characteristic of forward channel transmission from the gateway to the terminal, wherein the characteristic is determined by the gateway based on a measurement by the terminal that is reported to the gateway.

17. The computer-implemented method of claim 1, wherein determining the characteristic of the wireless channel comprises determining a characteristic of reverse channel transmission from the terminal to the gateway, wherein the characteristic is measured by the gateway based on signal characteristics of one or more transmissions from the terminal.

18. The computer-implemented method of claim 1, wherein determining the characteristic of the wireless channel comprises estimating a signal-to-noise ratio (SNR) for the terminal or a signal-to-interference-and-noise ratio (SINR) for the terminal based on a geographical location of the terminal.

19. A system comprising:
one or more computers and one or more storage devices storing instructions that are operable, when executed by the one or more computers, to cause the one or more computers to perform operations comprising:
determining a number of resource blocks to use for one or more communications between a terminal and a gateway in a satellite communication network, wherein the number of resource blocks indicates an amount of frequency bandwidth to use for the one or more communications;
determining a characteristic of a wireless channel used for communication between the terminal and the gateway in the satellite communication network;
selecting a table from a plurality of tables, wherein each of the tables specifies transmission parameters to use for different combinations of (i) values indicating different numbers of resource blocks and (ii) values indicating different wireless channel characteristics;
determining transmission parameters for making the one or more communications between the terminal and the gateway based on an entry, retrieved from the identified table, that corresponds to (i) the determined number of resource blocks and (ii) the determined characteristic of the wireless channel; and
causing one or more transmissions to be sent between the terminal and the gateway using the determined transmission parameters.

20. One or more non-transitory computer-readable media storing software comprising instructions that are operable, when executed by one or more computers, to cause the one or more computers to perform operations comprising:
determining a number of resource blocks to use for one or more communications between a terminal and a gateway in a satellite communication network, wherein the number of resource blocks indicates an amount of frequency bandwidth to use for the one or more communications;
determining a characteristic of a wireless channel used for communication between the terminal and the gateway in the satellite communication network;
selecting a table from a plurality of tables, wherein each of the tables specifies transmission parameters to use for different combinations of (i) values indicating different numbers of resource blocks and (ii) values indicating different wireless channel characteristics;
determining transmission parameters for making the one or more communications between the terminal and the gateway based on an entry, retrieved from the identified table, that corresponds to (i) the determined number of resource blocks and (ii) the determined characteristic of the wireless channel; and
causing one or more transmissions to be sent between the terminal and the gateway using the determined transmission parameters.
